(19) United States
(12) Patent Application Publication
(10) Pub. No.: US 2025/0375355 A1
(43) Pub. Date: Dec. 11, 2025

(54) CHECKING APPARATUS AND MEDICATION SUPPORT APPARATUS

(71) Applicants: Natsuki Koike, Kanagawa (JP); Hirotaka Hayashi, Kanagawa (JP); Manabu Yamanaka, Kanagawa (JP); Youhei Niitsuma, Kanagawa (JP); Takato Mochizuki, Kanagawa (JP); Sachika Tashiro, Kanagawa (JP); Yoshihide Sugiyama, Kanagawa (JP); Hiroshi Fujie, Kanagawa (JP)

(72) Inventors: Natsuki Koike, Kanagawa (JP); Hirotaka Hayashi, Kanagawa (JP); Manabu Yamanaka, Kanagawa (JP); Youhei Niitsuma, Kanagawa (JP); Takato Mochizuki, Kanagawa (JP); Sachika Tashiro, Kanagawa (JP); Yoshihide Sugiyama, Kanagawa (JP); Hiroshi Fujie, Kanagawa (JP)

(73) Assignee: Ricoh Company, Ltd., Tokyo (JP)

(21) Appl. No.: 19/224,851

(22) Filed: Jun. 1, 2025

(30) Foreign Application Priority Data
Jun. 10, 2024 (JP) 2024-093854

(51) Int. Cl. A61J 7/00; A61J 1/03; B65G 1/137

(52) U.S. Cl. CPC A61J 7/0069; A61J 1/03; B65G 1/1371; A61J 2200/70; A61J 2205/60; B65G 2203/0216

(57) ABSTRACT

A checking apparatus includes circuitry to check a relation between a medicine placement unit and one of a container and a medicine package stored in the container, obtain comparison data, compare the comparison data with first data read by a first data reader from a first data retaining medium disposed on the one of the container and the medicine package and second data read by a second data reader from a second data retaining medium disposed on the medicine placement unit, and output a result of comparison performed between the comparison data and each one of the first data and the second data.

### CROSS-REFERENCE TO RELATED APPLICATION

This patent application is based on and claims priority pursuant to 35 U.S.C. § 119(a) to Japanese Patent Application No. 2024-093854, filed on Jun. 10, 2024, in the Japan Patent Office, the entire disclosure of which is hereby incorporated by reference herein.

### BACKGROUND

### Technical Field

The present disclosure relates to a checking apparatus and a medication support apparatus.

### Background Art

Medication support apparatuses have been proposed that convey a medicine package stored in a container to a corresponding medicine placement unit.

For example, medication support apparatuses have been proposed that convey a medicine package picked up from a cartridge or a container to a corresponding subdivision box or a medicine placement unit of a medicine dispensing tray. Such a medication support apparatus includes a pack data management system that performs management based on the medication-related information of the medicine package including at least the name of a patient who takes medicines and the times of medication, and a medicine-dispensing data management system that reads and manages medicine-dispensing data including at least the name of the patient who takes medicines and the time of medication. In such a medication support apparatus, medicine-dispensing data is checked against medication-related information, and a medicine package that is picked up from a cartridge or a container is automatically conveyed to a corresponding subdivision box.

### SUMMARY

The present disclosure described herein provides a checking apparatus including circuitry to check a relation between a medicine placement unit and one of a container and a medicine package stored in the container, obtain comparison data, compare the comparison data with first data read by a first data reader from a first data retaining medium disposed on the one of the container and the medicine package and second data read by a second data reader from a second data retaining medium disposed on the medicine placement unit, and output a result of comparison performed between the comparison data and each one of the first data and the second data.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medicine dispensing apparatus that makes up a medication support apparatus.

FIG. 1B is a side view of the medicine dispensing apparatus of FIG. 1A.

FIG. 2A is a plan view of a single medicine package.

FIG. 2B is a side view of the single medicine package of FIG. 2A viewed in a direction indicated by an arrow A.

FIG. 2C is a side view of continuous medicine packs where a plurality of medicine packages of FIG. 2A are bound.

FIG. 2D is a plan view of the continuous medicine packs of FIG. 2C.

FIG. 3 is an external perspective view of a medicine dispensing tray attached to the medicine dispensing apparatus of FIG. 1A.

FIG. 4A is a diagram illustrating the attachment of a label with a quick response code to be placed in a subdivision box of the medicine dispensing tray of FIG. 3.

FIG. 4B is a diagram illustrating how the label of FIG. 4A with a QR CODE is displayed.

FIG. 5A is a vertical sectional view of a cartridge arranged in a medicine dispensing apparatus.

FIG. 5B is a bottom view of the cartridge of FIG. 5A.

FIG. 6A is another vertical sectional view of a cartridge different from that of FIG. 5A.

FIG. 6B is a bottom view of the cartridge of FIG. 6A.

FIG. 7 is a schematic plan sectional view of the attaching and detaching mechanisms for a cartridge, which are arranged on a drawer of a medicine dispensing apparatus.

FIG. 8 is a schematic plan view of cartridges, illustrating the mechanisms for recognizing each one of the cartridges arranged in a drawer.

FIG. 9A is a front view of a carriage of a medicine dispensing apparatus, illustrating a schematic configuration or structure of the carriage.

FIG. 9B is a plan view of the carriage of FIG. 9A.

FIG. 10 is a front view of a carriage, illustrating the progression of the operation of the carriage.

FIG. 11A to FIG. 11F are front views of a carriage, illustrating the progression of the operation of the carriage subsequent to the operation illustrated in FIG. 10.

FIG. 12A to FIG. 12C are front views of a carriage, illustrating the progression of the operation of the carriage subsequent to the operation illustrated in FIG. 11A to FIG. 11F.

FIG. 13 is a front view of a cartridge, illustrating the operation of scanning a QR CODE displayed on the cartridge.

FIG. 14A is a front view of a conveyor, illustrating a schematic configuration of the conveyor provided for a medicine dispensing apparatus.

FIG. 14B is a side view of the conveyor of FIG. 14A, illustrating a schematic configuration of the conveyor.

FIG. 15 is a diagram illustrating the control blocks of a medicine dispensing apparatus.

FIG. 16A to FIG. 16C are schematic diagrams of a cartridge sensor that detects the attachment and detachment (or loading and unloading) of a cartridge.

FIG. 17A and FIG. 17B are diagrams of a cartridge tray to which a cartridge is not yet attached.

FIG. 17C and FIG. 17D are diagrams illustrating a cartridge tray to which a cartridge is attached.

FIG. 18 is a bottom view of multiple cartridge trays on each of which a cartridge sensor is mounted.

FIG. 19 is a diagram illustrating the flow of the procedure in an entire medication support system for helping a patient who takes medicines to take the medicines arranged by a pharmacy, in a day-care center or nursing home.

FIG. 20 is a diagram illustrating functional blocks of a medicine dispensing system including a medicine dispensing apparatus 200 and a personal computer (PC) in a day-care center or nursing home.

FIG. 21 is a table depicting delivery data obtained by an inspection management system from a database file of a memory.

FIG. 22 is a table indicating a result of the inspection performed by an inspection management system.

FIG. 23 is a flowchart of an operation in which inspection is performed by an inspection management system.

FIG. 24 is a diagram illustrating first and second inspections.

FIG. 25 is a diagram illustrating what is displayed by a management application when a database file is read by an inspection management system.

FIG. 26 is a screen display displayed when inspection is performed or a result of the inspection is displayed.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers, or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

A medication support apparatus provided with a checking apparatus is described below with reference to the drawings. Firstly, elements of a medicine dispensing apparatus 200 that make up a medication support apparatus are described.

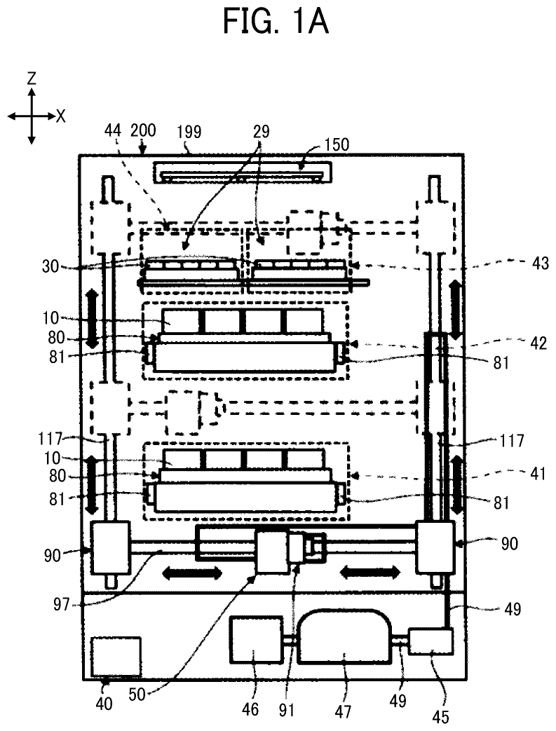

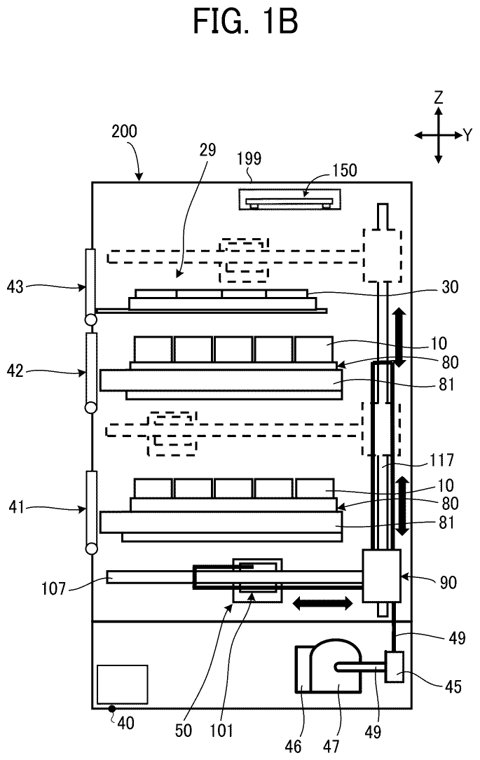

FIG. 1A is a schematic front view of the medicine dispensing apparatus 200, illustrating a basic and overall configuration or structure of the medicine dispensing apparatus 200.

FIG. 1B is a schematic side view of the medicine dispensing apparatus 200 of FIG. 1A, illustrating its configuration or structure.

In FIG. 1A and FIG. 1B, the lateral direction, the depth direction, and the vertical direction of the medicine dispensing apparatus 200 are referred to as the X-axis direction, the Y-axis direction, and the Z-axis direction, respectively. The same applies to the other drawings given below.

As illustrated in FIG. 1A and FIG. 1B, the medicine dispensing apparatus 200 is provided with a cartridge 10 that is also referred to as a container, a cartridge tray 20 that is an example of a container holder, a drawer 80, a medicine dispensing tray 30, a carriage 50 that is also referred to as a pickup device, a conveyor 90, and a first gate 41 to a fourth gate 44.

Each one of the cartridges 10 is an example of a container in which a plurality of medicine packages, medicine packs, or continuous medicine packs packing a several kinds of medicines are stored upon being stacked on top of each other in layers. The medicine package according to the present embodiment may be referred to simply as a pack in the following description, and continuous packs will be described later in detail. The multiple cartridges 10 are arranged at a middle portion and a lower portion of the housing 199 of the medicine dispensing apparatus 200 through the cartridge tray 20. The multiple cartridges 10 are attachable to and detachable from the cartridge tray 20. The expression “stored upon being stacked on top of each other in layers” in the present disclosure indicates keeping the packs horizontally in such a manner that the front face is viewable.

The cartridge tray 20 can align and store the multiple cartridges 10, and the cartridge tray 20 is an example of a container in which at least one of the multiple cartridges 10 is placed and held.

The cartridges 10 are placed in the pair of drawers 80 through the cartridge tray 20. One of the pair of drawers 80 is arranged at a lower area of the housing 199 of the medicine dispensing apparatus 200, and the other one of the pair of drawers 80 is arranged at a middle area of the housing 199 of the medicine dispensing apparatus 200. In the case of the medicine dispensing apparatus 200 as illustrated in FIG. 1A and FIG. 1B, twenty cartridges 10 (4×5=20) are placed and held in one of the cartridge trays 20 of one of the pair of drawers 80. For the sake of explanatory convenience, each one of the multiple drawers 80 may be referred to as the cartridge tray 20 in the following description.

Each of the multiple cartridges 10 is placed and housed in a partitioned lattice-like side wall and bottom wall in the cartridge tray 20. On the bottom wall of the cartridge tray 20 corresponding to the cartridges 10, a rectangular through opening 21 through which a pack can be picked up from below one of the multiple cartridges 10, making use of the elasticity or free deformation of the pack as will be described later in detail, is formed.

The drawer 80 can align and hold the cartridge tray 20. In other words, a pair of slide rails 81 are attached to the outer side wall of the drawer 80, and a rail that engages with the slide rails 81 of the drawer 80 is arranged on the housing 199. Due to such an engagement between the rail of the housing 199 and the slide rail 81, the drawer 80 in which one of the multiple cartridge trays 20 is stored and held can be pulled out from the housing 199.

In the medicine dispensing tray 30 that is an example of a medicine placement unit holder, a plurality of subdivision boxes 34 as will be described later in detail are placed and held. Each one of the subdivision boxes 34 is an example of a medicine placement unit in which the prescribed packs conveyed by the conveyor 90 are arranged. As illustrated in FIG. 1A and FIG. 1B, a pair of medicine dispensing trays 30 are arranged above the multiple cartridges 10 mounted on the cartridge tray 20 in the uppermost one of the multiple drawers 80. An area in which the medicine dispensing tray 30 is arranged and packs are passed to the medicine dispensing tray 30 such that medicines are automatically dispensed may be referred to as a medicine dispensing area 29 in the following description.

The carriage 50 is an example of the pickup device that picks up a specific pack from one of the multiple cartridges 10, and partly serves as the conveyor 90. A portion of the conveyor 90 is an example of a conveyor that conveys the pack picked up from the cartridge 10 by the carriage 50. In other words, the carriage 50 and the conveyor 90 make up a conveyor that picks up a specific pack from a cartridge and conveys it to the subdivision boxes 34 of the medicine dispensing tray 30 that is an example of a medicine placement unit.

Each one of the first gate 41 and the second gate 42 allows one of the multiple cartridges 10 and the cartridge tray 20 to enter and exit the housing 199 through the drawer 80. The multiple cartridges 10 are inserted and set in the housing 199 through each one of the first gate 41 and the second gate 42. The open and close door of one of the first gate 41 and the second gate 42 are opened, and the drawer 80 in which the multiple cartridge trays 20 are aligned is drawn out to the front side. By so doing, the multiple cartridges 10 or the multiple cartridge trays 20 are inserted or withdrawn.

The third gate 43 and the fourth gate 44 allow the multiple medicine dispensing trays 30 that are arranged in two rows at the uppermost stage of the medicine dispensing apparatus 200 to enter and exit the housing 199. The third gate 43 and the fourth gate 44 are arranged such that the packs can be taken out immediately after the packs are set or inserted into the subdivision boxes 34 of the medicine dispensing tray 30.

In the medicine dispensing apparatus 200, two medicine dispensing trays 30 are arranged as described above, and as will be described later in detail, a plurality of medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The multiple cartridge trays 20 as illustrated in FIG. 1A and FIG. 1B are collectively arranged in upper and lower two stages below the multiple medicine dispensing trays 30 arranged uppermost. However, no limitation is intended thereby, and the multiple cartridge trays 20 as illustrated in FIG. 1A and FIG. 1B may collectively be arranged on an upper side or may collectively be arranged on a lower side. Depending on the number of persons in the day-care center or nursing home, the multiple cartridge trays 20 may be arranged in three or more stages to achieve similar advantageous effects.

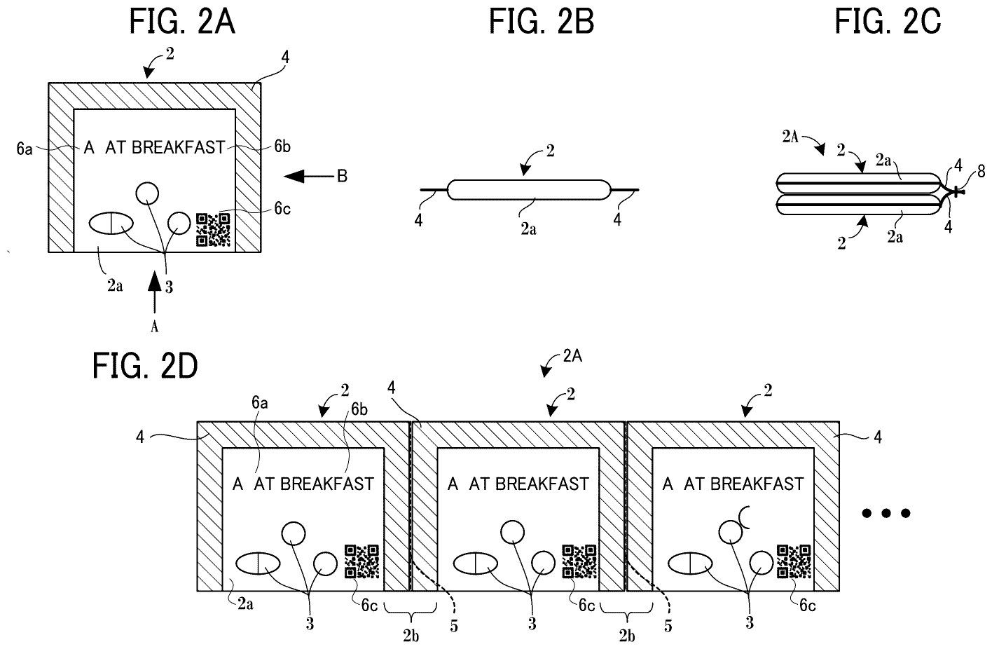

FIG. 2A is a typical plan view of a single medicine package 2.

FIG. 2B a side view of the single medicine package 2 of FIG. 2A viewed in a direction indicated by an arrow A.

FIG. 2C is a side view of the continuous medicine packs 2A in which the medicine packages 2 are stacked on top of each other in layers.

FIG. 2D is a plan view of a typical form of the continuous medicine packs 2A of FIG. 2C.

The medicine pack according to the present embodiment includes, for example, a single medicine package 2 and the continuous medicine packs 2A in which a plurality of medicine packages 2 are stacked on top of each other in layers and bound by, for example, a stapler. The continuous medicine packs 2A may be referred to simply as continuous packs 2A in the following description. In FIG. 2C, two medicine packages 2 are bound as the continuous medicine packs 2A. In the present embodiment, a single medicine package 2 will represent the medicine packages 2 or the continuous packs 2A.

As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that serve as packages and are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided in small quantities, and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 2A in the following description.

In the continuous packs 2A that are described with reference to FIG. 2D, the multiple medicine packages 2 are coupled to each other and laid like a belt. In the present embodiment described with reference to FIG. 2D, the medicines 3 for three doses are illustrated. The continuous packs 2A are a typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution. For the sake of explanatory convenience, each one of the packs is filled with the medicines 3 of the same form in the following description. In FIG. 2C, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A, FIG. 2B, FIG. 2C, and FIG. 2D, the medicine package 2 has a rectangular shape in a plan view, and a packaging method in which three sides are crimped and sealed as in the present embodiment is called three-sided packaging in the related art. Most of the drug-dispensing machines available on the market make packs using the three-sided packaging method.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. In the generation or dispensing by a drug-dispensing machine, a boundary portion 2b that is implemented by perforation 5 is formed in the center of the pressure-bonded portion 4 between a pair of the multiple medicine packages 2 making up the continuous packs 2A. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, continuous packs 2A may be used. The continuous packs 2A are formed by fastening multiple medicine packages 2 at the center of the three sides of the pressure-bonded portions 4 by stapling 8 (see FIG. 2C) or the like. In FIG. 2C, two medicine packages 2 are fastened together. For example, the continuous packs 2A may be formed by taping a plurality of packs together. Alternatively, the continuous packs 2A may be, for example, packs of Chinese herbal medicines or sheets of blister packs that are combined together.

As medication-related information such as the name of a patient who takes medicines and the times of medication, the medication-related information is added to the surface of the bag 2a of the medicine package 2. More specifically, texts 6a that indicate the medication-related information such as the name of a patient who takes the medicine 3 in the medicine package 2, texts 6b that indicate the medication-related information such as the times of medication at which the medicine 3 is taken, and a quick response (QR) CODE 6c that is an example of first data retaining medium and a two-dimensional code obtained by encoding the medication-related information including the name of a patient who takes medicines and the times of medication are arranged on the medicine package 2 as illustrated in FIG. 2A, FIG. 2B, FIG. 2C, and FIG. 2D. As illustrated in FIG. 2A, FIG. 2B, FIG. 2C, and FIG. 2D, the medication-related information that is textual information is added to the medicine package 2 as the texts 6a and 6b and the QR CODE 6c. However, no limitation is intended thereby, and one of the QR CODE 6c and the texts 6a and 6b may be added. Alternatively, for example, a data retaining medium or recording medium such as a radiofrequency identification (RFID) tag that is used when tag information is read using a one-dimensional bar code or short-range radio may be used.

Further, the medication-related information may be, for example, the type of the medicine or the shape of the medicine prescribed in a pack, the number of tablets, and the images or texts printed on the medicine itself. As the medication-related information, only individual information may be acquired and used, or items of information may be acquired and used in combination. For example, if confirmation of the patient who takes medicines is required, the information about the name of the patient who takes medicines is sufficient. If it is desired to prevent forgetting to take an important medicine, the information of the number of tablets of the medicine and the shape of the medicine in the pack is confirmed together with the information of the patient who takes medicines. The medication-related information includes, for example, at least one of the name of a patient who takes medicines, the times of medication at which the medicines in a pack are to be taken, and the number of tablets and types of the medicines prescribed in the pack.

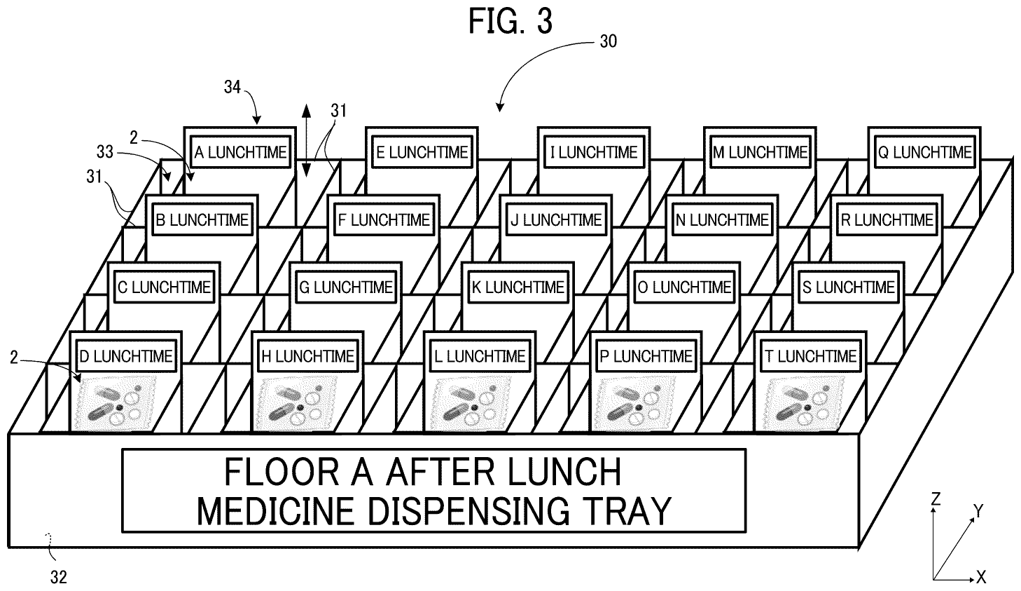

FIG. 3 is an external perspective view of the medicine dispensing tray 30, illustrating one configuration of the medicine dispensing tray 30.

As illustrated in FIG. 3, each one of the multiple medicine dispensing trays 30 has a plurality of upright partition walls 31 that serve as a plurality of dividers used to arrange prescribed packs, and is partitioned into twenty rooms 33 by four upright partition walls 31. The twenty rooms 33 that are formed in each one of the multiple medicine dispensing trays 30 can be expressed as the components of a matrix including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, each one of the medicine dispensing trays 30 is arranged such that specific one of the multiple packs arranged in specific one of the rooms 33 will be placed in specific one of the rooms 33 with reliability by the upright partition walls 31, which are four partition walls in the present embodiment, and the bottom wall 32 in common, without being mixed up with packs in different one of the rooms 33 or dropping off from the bottom wall 32.

In the medicine dispensing tray 30 as illustrated in FIG. 3, “FLOOR A AFTER LUNCH MEDICINE DISPENSING TRAY” displayed on the front outer wall indicates that the tray is the medicine dispensing tray 30 in which the multiple packs to be taken after lunch by patients who take medicines and reside in the same floor A of, for example, a day-care center or nursing home are arranged.

FIG. 3 illustrates one of the multiple medicine dispensing trays 30 where a subdivision box 34 that is an example of a medicine placement unit attachable to and detachable from each one of the multiple rooms 33 is used. For example, the multiple subdivision boxes 34 hold the multiple medicine packages 2 filled with the medicines 3 to be taken by twenty residents A to T after lunch in a day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34. The operation of placing the multiple medicine packages 2 in one of the multiple medicine dispensing trays 30 is briefly described later with a case in which the multiple subdivision boxes 34 are not used. In such cases, each one of the multiple rooms 33 of one of the multiple medicine dispensing trays 30 serves as a medicine placement unit.

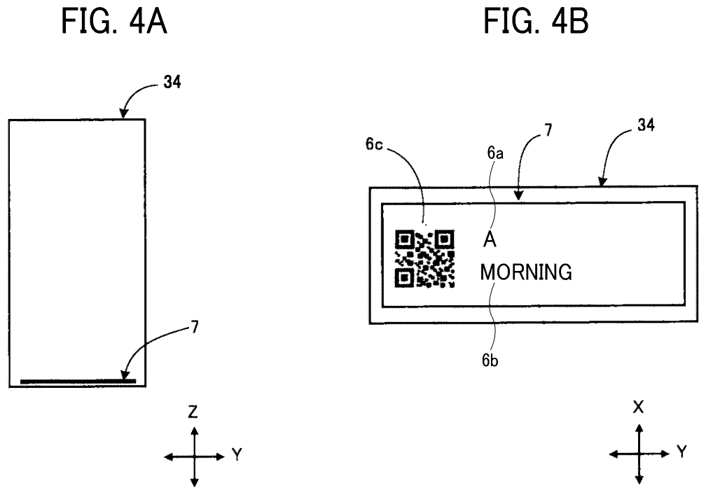

FIG. 4A is a diagram illustrating the attachment of the label 7 with a QR code to be placed in the subdivision box 34 used for the medicine dispensing tray 30.

FIG. 4B is a diagram illustrating how a label 7 with a QR CODE is displayed.

In order to specify the place to which one of the multiple medicine packages 2 picked up from one of the multiple cartridges 10 is to be dispensed, the label 7 with a QR code on which the texts 6a that indicate the name of a patient who takes medicines, the texts 6b that indicate the times of medication, and the QR code 6c that is an example of a second data retaining medium in which the name of a patient who takes medicines or the time of medication are encoded are printed is pasted on the inner bottom face of one of the multiple subdivision boxes 34 of the medicine dispensing tray 30.

The QR CODE of the label 7 with a QR code is read by the lower QR code reader 67 that is an example of a medication-related information reader unit or a second data reader that will be described later in detail, and the coordinates of the X position and the Y position, which are the information about the position of the carriage 50, are linked to a QR CODE that indicates the name of a patient who takes medicines and the times of medication. By so doing, the pack that is picked up from one of the multiple cartridges 10 can be dispensed to a desired position. For example, label 7 with a QR code may be directly attached to the subdivision box 34 in the form of a seal, or may be attached to an independently-prepared plate and arranged in the subdivision box 34.

The label 7 with the QR CODE 6c may be pasted to each one of the multiple rooms 33 of one of the multiple medicine dispensing trays 30, or a plate may be attached to each one of the multiple rooms 33 as described above when the subdivision box 34 is not to be used. When the subdivision box 34 is used, the subdivision box 34 in which the multiple medicine packages 2 are stored can be picked up from the medicine dispensing tray 30, and a proper medicine package 2 can be passed to an occupant or patient who takes medicines. Accordingly, there is little worry about taking a wrong pack or dropping the pack.

In each one of the multiple rooms 33 of the multiple medicine dispensing trays 30, a setting position or inserting position is determined for each patient who takes medicines depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, the arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30. Allocating the rooms 33 based on each time of medication such as a time in the morning, a time in the daytime, a time in the evening, and a time before going to bed can prevent the time of medication from being mistaken by patients who take medicines.

The cartridge 10 is described below.

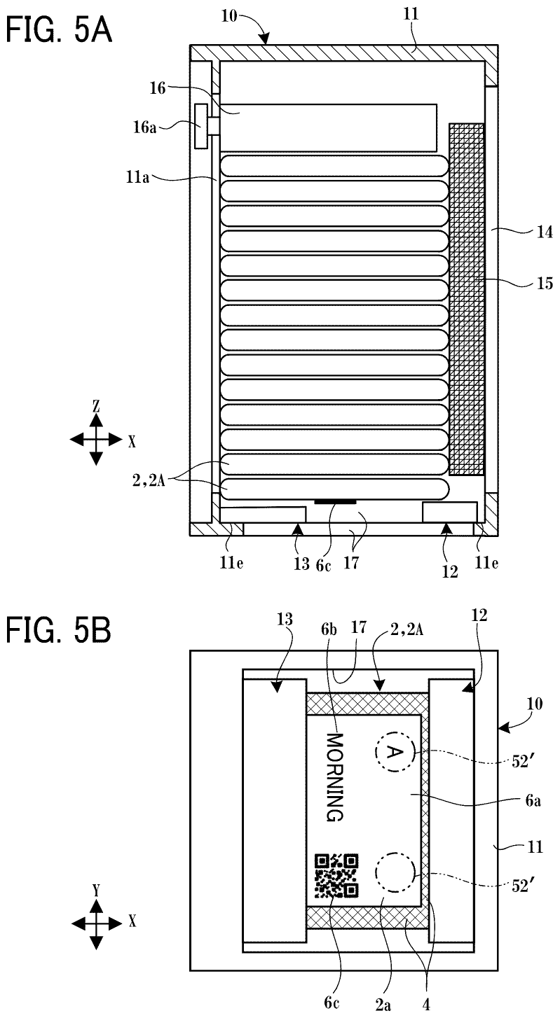

FIG. 5A is a vertical sectional view of the cartridge 10.

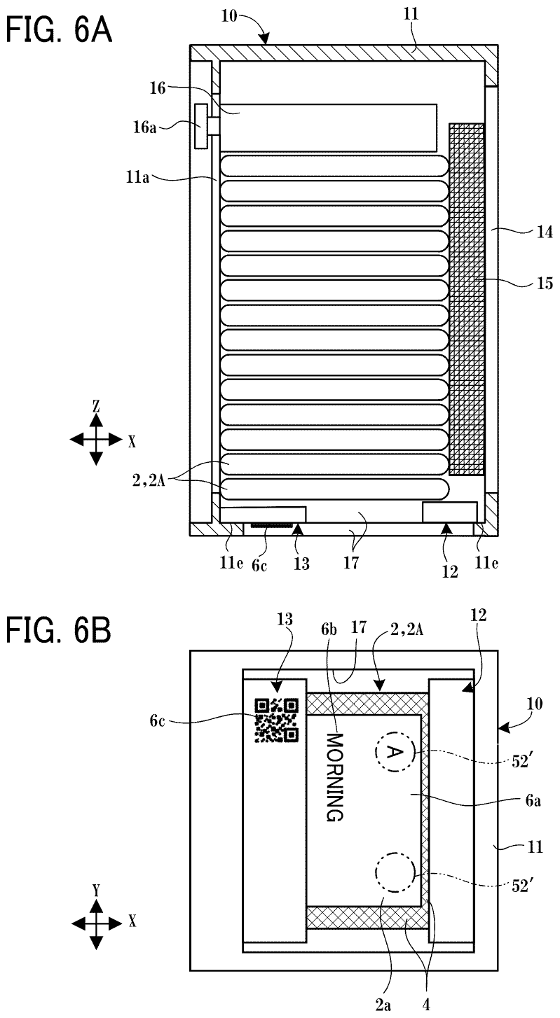

FIG. 6A is another vertical sectional view of one of the multiple cartridges 10 different from that of FIG. 5A.

FIG. 5B is a bottom view of the cartridge 10 of FIG. 5A.

FIG. 6B is a bottom view of the cartridge 10 of FIG. 6A.

In order to simplify the drawing, the illustration of the pressure-bonded portions 4 (see FIG. 2A, FIG. 2B, FIG. 2C, and FIG. 2D) of the multiple medicine packages 2 stored in one of the multiple cartridges 10 is omitted in the pair of vertical sections of FIG. 5A and FIG. 6A, and the medicine packages 2 are schematically illustrated in an enlarged and exaggerated manner. For the same purpose, the hatching of the cross sections of the supporters such as the right support portion 12 and the left support portion 13 is also omitted. One of the multiple cartridges 10 as illustrated in FIG. 5A and FIG. 5B is equivalent to one of the multiple cartridges 10 as illustrated in FIG. 6A and FIG. 6B in terms of, for example, the shape. The display position and the display member of the QR code 6c are different between FIG. 5A and FIG. 6A and between FIG. 5B and FIG. 6B. The configuration or structure in terms of, for example, the shape is described with reference to FIG. 5A and FIG. 5B.

For example, each one of the multiple cartridges 10 includes a casing 11, a lid 14, a pack pickup slot 17, a movable board 16, a pack posture keeper 15, and a right support portion 12 and a left support portion 13 each of which serves as a support portion.

The casing 11 stores, for example, multiple medicine packages 2 or the continuous packs 2A. In the following description, a single medicine package 2 will represent such multiple medicine packages 2 or continuous packs 2A. For example, the casing 11 is integrally or separately formed using resin. The lid 14 enables the multiple medicine packages 2 to be loaded or unloaded. The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50, to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 also support or hold the medicine package 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at a plurality of points, one of the multiple medicine packages 2 to be picked up from one of the multiple cartridges 10.

The right support portion 12 and the left support portion 13 are configured to allow one of the multiple medicine packages 2 to pass through when one of the multiple medicine packages 2 is picked up from one of the multiple cartridges 10 by the carriage 50. On the other hand, when any one of the multiple medicine packages 2 is not to be picked up from one of the multiple cartridges 10, the multiple medicine packages 2 are to be stored and held in the casing 11. In order to achieve that, the right support portion 12 and the left support portion 13 are configured to restrict the passage of one of the multiple medicine packages 2

As described above, the right support portion 12 and the left support portion 13 serve as a pair of support portions that support or hold the multiple medicine packages 2 in the one of the multiple cartridges 10, and each one of the right support portion 12 and the left support portion 13 is fixed and immovable such that one of the multiple medicine packages 2 can be picked up in a stable manner from one of the multiple cartridges 10 by the carriage 50. The right support portion 12 and the left support portion 13 are a pair of fixation members that are fixed or attached to the pair of bottom-wall inner surfaces 11e of the right bottom-wall edge and left bottom-wall edge of the pack pickup slot 17, respectively.

The pack pickup slot 17 has both a function to allow the suction pad 52 of the carriage 50 to pass therethrough in order to pick up one of the multiple medicine packages 2 and a function to allow the picked-up medicine package 2 and the suction pad 52 to pass therethrough. In other words, the pack pickup slot 17 and the above right bottom-wall edge and left bottom-wall edge that are arranged so as to surround the pack pickup slot 17 together serve as a pack passing-through portion according to the present embodiment.

In one of the multiple cartridges 10 illustrated in FIG. 5A and FIG. 5B, a pair of positions 52′ at which the pair of suction pads 52 adsorb or suck up one of the multiple medicine packages 2 stored in one of the multiple cartridges 10 are indicated by a pair of ring-shaped dot-dot-dash lines as illustrated in FIG. 5B. Such a pair of positions may be referred to as a pair of suction pad positions in the following description. The right support portion 12 and the left support portion 13 that are arranged underneath one of the multiple cartridges 10 support the multiple medicine packages 2 in one of the multiple cartridges 10 such that the multiple medicine packages 2 in one of the multiple cartridges 10 do not fall from the pack pickup slot 17. As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the medicine packages 2 is picked up from one of the multiple cartridges 10 by the pair of suction pads 52, the pair of suction pads 52 pass near both ends of the right support portion 12 in the Y-axis direction to suck and hold one of the medicine packages 2.

As illustrated in FIG. 5B, two positions 52′ at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can successfully be done. In other words, the medicine package 2 is sucked and adhered to the pair of suction pads 52 at both ends in the Y-axis direction, and the bag 2a of the medicine package 2, which is made of film, is stretched by the suctioning of the pair of suction pads and withstands the deformation. Accordingly, both reliable support or holding of the multiple medicine packages 2 in one of the multiple cartridges 10 and smooth removal of one of the multiple medicine packages 2 can be achieved.

The pack posture keeper 15 is formed of sponge rubber having appropriate elasticity. The movable board 16 is made of, for example, resin or metal. The pack posture keeper 15 and the movable board 16 hold the posture of the multiple medicine packages 2 under normal operating conditions in the casing 11. As explicitly illustrated in FIG. 5A, the posture of the multiple medicine packages 2 is held orderly in the Z-axis direction in a substantially horizontal state. In order to achieve the above-described function, the movable board 16 is arranged to move at least one of the multiple medicine packages 2 left in the casing 11 toward the pack pickup slot 17 as moving downward in the casing 11 in the Z-axis direction by its own weight.

As illustrated in FIG. 5A, a long groove 11a that extends in the Z-axis direction with predetermined width in the X-axis direction is formed in the side wall of the casing 11. A shaft 16a with a flange is arranged at one end of the movable board 16 so as to protrude from the long groove 11a. As the shaft 16a of the movable board 16 is guided in the Z-axis direction parallel to the long groove 11a, the posture of the multiple medicine packages 2 can be held in the Z-axis direction. In FIG. 5A and FIG. 5B, the multiple medicine packages 2 in the multiple cartridges 10 are stacked on top of each other in layers in a substantially horizontal state. However, in actuality, left portions of the medicine packages 2 in FIG. 5A and FIG. 5B filled with the medicines 3 are expanding.

A set of the multiple medicine packages 2 are orderly stored in the casing 11 toward the upper side from the pack pickup slot 17 on the right support portion 12 and the left support portion 13. The timing at which the multiple medicine packages 2 are supplied into one of the multiple cartridges 10 may be, for example, the timing at which a patient who takes medicines or occupant is examined in a day-care center or nursing home, which is typically once a two weeks, or the timing at which the multiple medicine packages 2 in one of the multiple cartridges 10 run out. When some medicine packages 2 are left in one of the multiple cartridges 10 at the time of replenishment, such replenishment is continued from the back of the remaining medicine packages 2. Under normal operating conditions, the above-described setting of the multiple medicine packages 2 into one of the multiple cartridges 10 and the replenishment of the multiple medicine packages 2 are done by a staff or the like in a day-care center or nursing home. However, no limitation is indicated thereby. In particular, in configurations where cartridges are used instead of containers and setting or replenishment of the medicine packages 2 are done automatically, the setting or replenishment of the medicine packages 2 may be done differently.

The lid 14 is used by a staff or the like who works at a day-care center or nursing home to enable loading or unloading of the multiple medicine packages 2 stored in one of the multiple cartridges 10, and as illustrated in FIG. 5A, is formed with wide length in the Z-axis direction of the casing 11 and has a predetermined opening width.

As illustrated in FIG. 5B, the types of the multiple medicine packages 2 in one of the multiple cartridges 10 are sorted or divided based on the timings at which medicines are taken. For example, one cartridge contains medicines to be taken in fourteen days in the morning by Mr. or Ms. A. In view of the above circumstances, if Mr. or Ms. A takes the medicines not only in the morning but also in the daytime or in the evening, or before going to bed, four cartridges 10 are required in total.

However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

In the present embodiment, the right support portion 12 and the left support portion 13 are fixed to the bottom-wall inner surface 11e of the pack pickup slot 17 of the casing 11 such that one of the multiple medicine packages 2 can be picked up in a stable manner from one of the multiple cartridges 10 by the carriage 50. In other words, the right support portion 12 and the left support portion 13 are fixed when the right support portion 12 and the left support portion 13 hold both ends of the medicine pack such as the medicine package 2 or the continuous packs 2A around the pack pickup slot 17 arranged at the lower portion of one of the multiple cartridges 10.

The medicine package 2 that is stored in the cartridge 10 is supported by a right support portion 12 and a left support portion 13 so as not to drop. The right support portion 12 supports a right end where the medicine package 2 is sucked up, and the left support portion 13 supports a left end on the other side. The right support portion 12 and the left support portion 13 are different in the length of the portion that support the multiple medicine packages 2, and the length of portion of the right support portion 12 that support the multiple medicine packages 2 is shorter than that of the left support portion 13. When the lowermost one of the multiple medicine packages 2 stored in one of the multiple cartridges 10 is adsorbed or sucked by the suction pad 52, the medicine pack such as the medicine packages 2 is bent or freely deformed due to its elasticity. Accordingly, the medicine pack can easily be pulled out.

In such a configuration, the pair of support portions including the right support portion 12 and the left support portion 13 are of fixed type. Accordingly, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

As illustrated in FIG. 5A and FIG. 5B, the texts 6a and 6b or the QR code 6c that are displayed on a medicine pack such as the medicine package 2 or the continuous packs 2A are exposed through the pack pickup slot 17 of one of the multiple cartridges 10. The QR code 6c on the medicine package 2 can be read by an upper QR code reader 66 that is an example of a first data reader mounted on the carriage 50. For the sake of explanatory convenience, in FIG. 5A and FIG. 5B, the QR code 6c is displayed only on, for example, the medicine package 2 or the continuous packs 2A that are stored at the bottom of one of the multiple cartridges 10, but the QR code 6c is displayed on, for example, all the medicine packages 2 or the continuous packs 2A that are stored in one of the multiple cartridges 10.

For example, when a drug-dispensing machine that makes, for example, the medicine package 2, cannot print coded image such as the QR code 6c on a medicine pack such as the medicine package 2 or the continuous packs 2A, the QR CODE may be arranged as illustrated in FIG. 6A and FIG. 6B. In other words, as illustrated in FIG. 6A and FIG. 6B, the label with QR code 6c is pasted to the bottom face of the left support portion 13 close to the pack pickup slot 17. As a result, the medication-related information of the medicine pack such as the medicine packages 2 or the continuous packs 2A that is stored in one of the multiple cartridges 10 can be obtained. In order to obtain the medication-related information, the QR code 6c may directly be printed on the cartridge 10 instead of pasting a label of the QR code 6c.

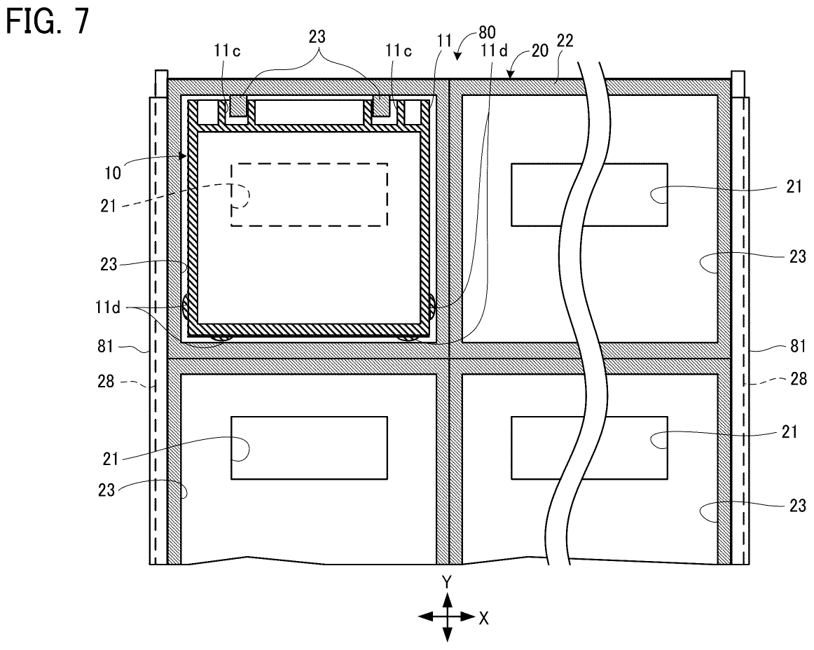

FIG. 7 is a schematic plan sectional view of the attaching and detaching mechanisms for the cartridge 10, which are arranged on the drawer 80.

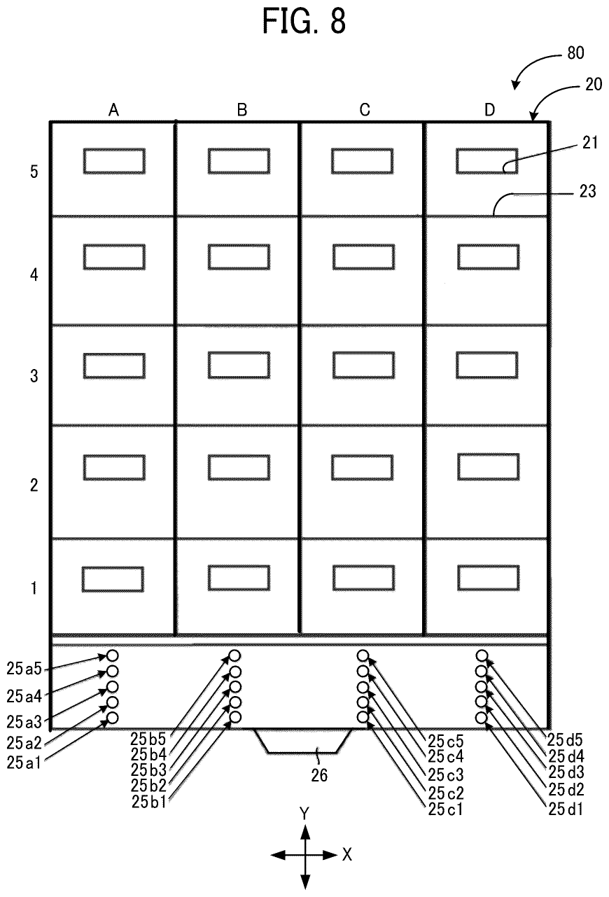

FIG. 8 is a schematic plan view of the cartridges 10, illustrating the mechanisms for recognizing each one of the cartridges, which are arranged in the drawer 80.

As illustrated in FIG. 7, the drawer 80 is configured to allow the multiple cartridges 10 to be attachable and detachable through the cartridge tray 20. The drawer 80 is integrally formed with the cartridge tray 20 to hold the cartridge tray 20. The casing 22 of the cartridge tray 20 in the drawer 80 is provided with a pair of slide rails 81 on the right and left outer side walls, respectively, and each one of the pair of slide rails 81 is slidable with one of the multiple rails provided for the housing 199 (see FIG. 1A and FIG. 1B). Due to such a configuration, the multiple cartridge trays 20 in the drawer 80 can be attached or detached by being pulled out from the housing 199 through the engagement between the slide rail 81 and the one of the multiple rails of the housing 199.

As illustrated in FIG. 7, one of the multiple cartridges 10 is attached to and detached from the cartridge tray 20 in the drawer 80 through the engagement and disengagement between a pair of concave portions 11c on the external wall of the casing 11 of the cartridge 10 and a pair of convex portions 23a that are formed on the inner wall of the casing 22 of the drawer 80 and protrude inwardly and the engagement and disengagement between the inner wall of the casing 22 and four hemispherical protrusions 11d on the external wall of the casing 11. With the above-described attaching and detaching mechanism of the drawer 80, the multiple cartridges 10 can be attached or detached easily and with good operability.

In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment. As illustrated in FIG. 7 and FIG. 8, a rectangular through opening 21 that communicates with the pack pickup slot 17 of one of the multiple cartridges 10 when each one of the multiple cartridges 10 is attached to each container 23 of the cartridge tray 20 is formed on the bottom wall of the cartridge tray 20 of the drawer 80.

As illustrated in FIG. 8, the cartridge tray 20 of the drawer 80 has containers 23 in which twenty cartridges 10 are stored. Each tray has four columns of A to D in the horizontal direction, and has five rows of 1 to 5 in the vertical direction. As illustrated in FIG. 8, the drawer 80 is provided with an information display device such as a plurality of light-emitting diodes (LEDs) 25al to 25d5 around a grip 26 that is held by hand to insert or withdraw the drawer 80. Due to such a configuration, the arrangement of the multiple cartridges 10 can easily be figured out. Detection units such as sensors or switches are provided for the containers 23 to recognize whether the cartridge 10 is present electrically or automatically, and the information display device provides notification of the result of recognition. More specifically, due to such a configuration, at what position one of the multiple cartridges 10 in focus is placed in the cartridge tray 20 of the drawer 80 can easily be figured out at a glance.

In FIG. 8, the light-emitting diode (LED) 25al is used to indicate the presence or absence of one of the multiple cartridges 10 attached to or detached from a storage unit A1 of the cartridge tray 20. The storage unit A1 indicates a position or partition that is uniquely determined in the vertical columns and horizontal rows. In a similar manner to the above, the LED 25a2 corresponds to a portion of the storage unit A2 of the cartridge tray 20, and the LED 25a3 corresponds to a portion of the storage unit A3 of the cartridge tray 20. Moreover, the LED 25a4 corresponds to a portion of the storage unit A4 of the cartridge tray 20, and the LED 25a5 corresponds to a portion of the storage unit A5 of the cartridge tray 20. In a similar manner to the above, as illustrated in FIG. 8, each one of three columns of B to D and five rows of 1 to 5 of the containers is provided with an LED that indicates whether one of the multiple cartridges 10, which is attached to and detached from one of the containers, is present.

The container may be provided with for example, a number, a bar code, a quick response code (QR CODE), or a non-contact integrated circuit (IC) tag such that each one of the containers will be identifiable. It is desired that the system be programmed to remember what container stores whose medicines. Subsequently, the drawer 80 to which the multiple containers are attached is set in the housing 199 of the medicine dispensing apparatus 200, and each one of the multiple containers is identified by the medicine dispensing apparatus 200. Due to such a configuration, a desired pack can be picked up by the medicine dispensing apparatus 200 without causing any errors.

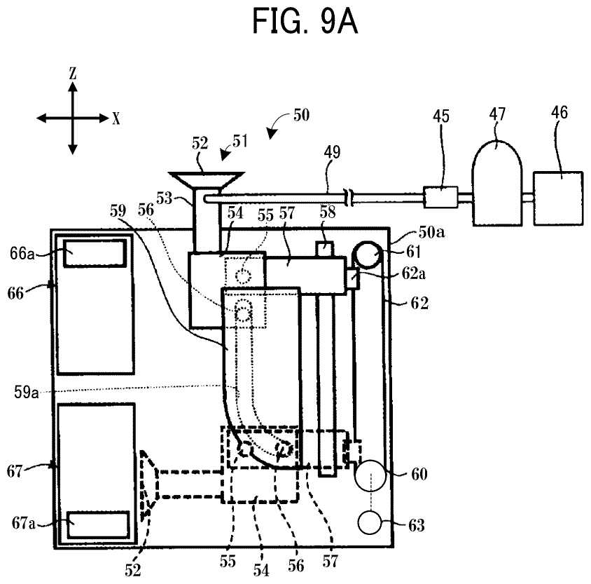

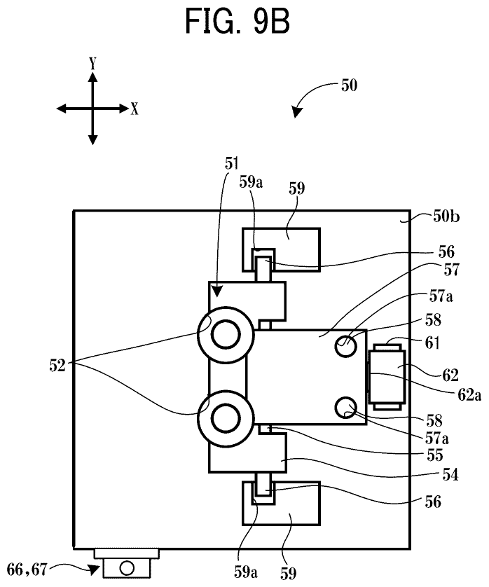

FIG. 9A is a front view of a carriage 50 illustrating a schematic configuration or structure of the carriage 50.

FIG. 9B is a plan view of the carriage 50 of FIG. 9A.

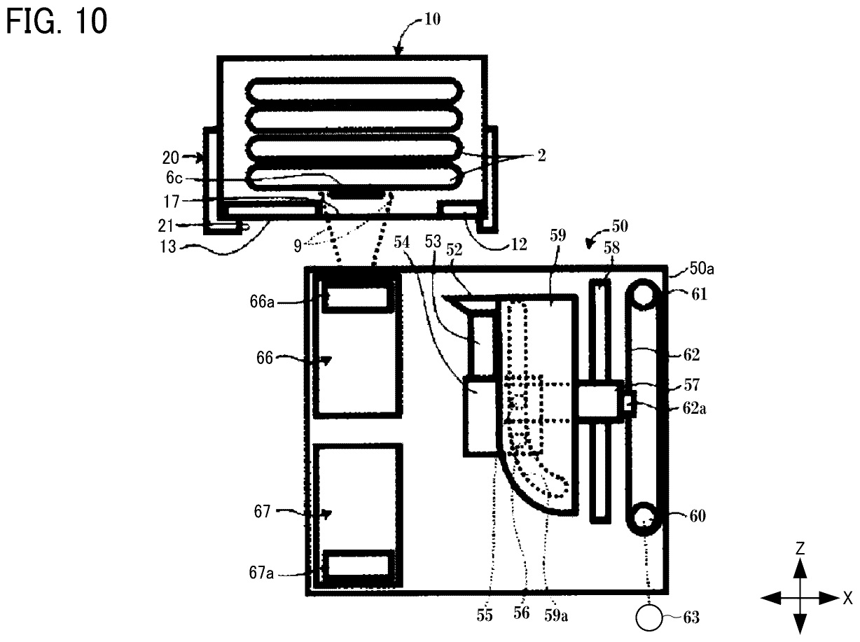

FIG. 10 to FIG. 12C are front views of the carriage 50, illustrating the progression of the operation of the carriage 50.

In order to simplify the drawing, how elements such as a negative-pressure generator 45 are connected to the carriage 50 is illustrated in FIG. 9A.

As illustrated in FIG. 9A and FIG. 9B, the carriage 50 includes a suction device 51 that picks up and holds one of the multiple medicine packages 2 from one of the multiple cartridges 10. The suction device 51 has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. The suction device 51 has a function to separate the medicine package 2 using the pressurized air generated by the negative-pressure generator 45 when the medicine package 2 is to be separated.

As illustrated in FIG. 9A, the suction device 51 as described above sucks up one of the multiple medicine packages 2 as the negative-pressure generator 45 transforms the positive pressure generated by an air compressor 46 that serves as an air compressing means into negative pressure through an air tank 47. The air compressor 46 is installed outside the conveyor 90, and is coupled to the suction device 51 through the air tank 47 and the negative-pressure generator 45 by a member for communication such as an air tube 49. A pressure sensor is provided for the air tube 49 arranged between the negative-pressure generator 45 and the suction device 51 to measure the negative pressure. Such a pressure sensor is arranged to determine that the suction device 51 has sucked up one of the multiple medicine packages 2 when the negative pressure measured by a pressure sensor that measures the negative pressure becomes equal to or less than a predetermined value.

The air tube 49 according to the present comparative example is arranged together with, for example, a CABLEVEYOR and a wire harness so as not to be stretched even when the carriage 50 moves inside the medicine dispensing apparatus 200. In other words, as illustrated in FIG. 1A and FIG. 1B, the air tube 49 according to the present comparative example has a one-turn path for each one of the X-axis, the Y-axis, and the Z-axis. Firstly, the air tube 49 is extended from the negative-pressure generator 45 in the Z-axis direction, and makes one turn. Secondly, the air tube 49 is extended in the X-axis direction, and makes one turn. Finally, the air tube 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air tube 49. Each one of the pair of suction pads 52 is an example of an air suction unit or a suction member that sucks up and picks up one of the multiple medicine packages 2 in one of the multiple cartridges 10. As described above, the upper ends of the pair of suction pads 52 as illustrated in FIG. 9A is arranged to absorb one of the multiple medicine packages 2. The bottom ends of the pair of suction pads 52 as illustrated in FIG. 9A is attached and fixed to the upper end of the suction duct 53 as illustrated in FIG. 9A. The bottom end of the suction duct 53 as illustrated in FIG. 9A is attached and fixed to the suction-pad supporting member 54. A pair of suction pads 52 and suction ducts 53 are arranged in the Y-axis direction.

The carriage 50 is provided with a posture changing unit used to change the posture of one of the multiple medicine packages 2 picked up from one of the multiple cartridges 10 to a substantially vertical posture. The posture changing unit in the carriage 50 includes, for example, a suction-pad supporting member 54 coupled to a suction device base 57 through a rotary shaft 55, a guide unit 59 formed with a guide groove 59a having a specific shape, a guide axis 56 that is fitted into the guide groove 59a of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may rotatably or pivotably be arranged around the rotary shaft 55 fixed to the suction-pad supporting member 54 within a range of a predetermined angle. Alternatively, the suction-pad supporting member 54 may rotatably or pivotably be arranged around the rotary shaft 55 fixed to the suction device base 57. In other words, in FIG. 9A and FIG. 9B, the distance between the center of the rotary shaft 55 and the center of a guide rod 58 in the X-axis direction, as will be described later in detail, is kept constant when the suction device base 57 moves along the guide rod 58 in up and down directions Z.

The suction-device lifting and lowering unit includes a pair of guide rods 58 that are arranged in the Y-axis direction, an endless belt 62 looped around a driving pulley 60 and a driven pulley 61, and a drive motor 63 coupled to the driving pulley 60 through a driving power conveyor such as a gear or a belt. The pair of guide rods 58 guide the suction device base 57 in the Z-axis direction. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. The pair of guide rods 58 are arranged at two different positions in the Y-axis direction, and extend in the Z-axis direction. The bottom ends of those guide rods 58 are fixed to the base frame 50b of the picking-up frame 50a provided for the carriage 50. A pair of guiding holes 57a into which the pair of guide rods 58 are inserted are formed around a right end of the suction device base 57. The pulley axis of each one of the driving pulley 60 and the driven pulley 61 is rotatably supported by an immovable member on the picking-up frame 50a. The drive motor 63 is fixed to an immovable member provided for the picking-up frame 50a of the carriage 50.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction unit lifting and lowering unit is not limited to the above-described up-and-down reciprocating mechanism driven by a belt. Alternatively, for example, the suction unit lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b. The guide axis 56 is arranged so as to protrude from both ends of the suction-pad supporting member 54 in the Y-axis direction, and is consistently fitted into the guide groove 59a of the guide unit 59 to guide the suction-pad supporting member 54. As illustrated in FIG. 9A, the guide axis 56 is provided below the rotary shaft 55 of the suction-pad supporting member 54 in the Z-axis direction with a certain distance from the rotary shaft 55.

When the suction device base 57 is moved in the Z-axis direction by the operation of the drive motor 63, the guide axis 56 of the suction-pad supporting member 54 is moved in the Z-axis direction parallel to the guide groove 59a having a specific shape while maintaining the posture of the suction device base 57 on the XY plane constant in a substantially horizontal state. Due to such a configuration, the posture of the suction pad 52 can be rotated by approximately 90 degrees. In FIG. 9A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

The guide groove 59a having a specific shape includes the first guide groove portion that extends in the Z-axis direction with relatively great length so as to hold the posture of the pair of suction pads 52 upward as indicated by solid lines in FIG. 9A through the suction-pad supporting member 54 in a substantially horizontal state as guided by the guide axis 56, and the second guide groove that gently draw an obtuse and shallow arc to the right side as it goes downward to rotate the posture of the suction-pad supporting member 54 and the pair of suction pads 52 by approximately 90 degrees. The first guide groove portion and the second guide groove communicate with each other and are coupled to each other.

As illustrated in FIG. 9A and FIG. 9B, the carriage 50 is provided with the upper QR code reader 66 that reads the QR code 6c displayed on, for example, the medicine package 2 stored in the cartridge 10. The upper QR code reader 66 has an upper reader unit 66a that reads the QR code 6c at an upper portion thereof, and also serves as a medication-related information reader unit 65.

The upper QR code reader 66 is attached to a side of the carriage 50. The upper QR code reader 66 is also used to read the QR code 6c displayed on the label (see FIG. 6A and FIG. 6B) pasted to the left support portion 13 of the pack pickup slot 17 in one of the multiple cartridges 10. For example, the QR code 6c is read by the upper reader unit 66a of the upper QR code reader 66 immediately before the medicine package 2 is picked up from one of the multiple cartridges 10 by the carriage 50.

As illustrated in FIG. 9A and FIG. 9B, the carriage 50 is provided with the lower QR code reader 67 that reads the QR CODE of the label 7 with QR code 6c that is pasted onto the subdivision box 34 described above with reference to FIG. 4A and FIG. 4B. The lower QR code reader 67 has a lower reader unit 67a that also serves as the medication-related information reader unit 65 at a lower portion thereof, and is attached to a side of the carriage 50 under the upper QR code reader 66. For example, the QR code 6c on the subdivision box 34 is read by the lower reader unit 67a of the lower QR code reader 67 immediately before the medicine package 2 picked up from one of the multiple cartridges 10 and is dispensed to desired one of the multiple subdivision boxes 34 of the medicine dispensing tray 30.

The operation of the carriage 50 will be described below. For the sake of explanatory convenience, it is assumed in the present embodiment that by the operation of the conveyor 90 illustrated in FIG. 1A and FIG. 1B, the carriage 50 is arranged below the cartridge tray 20 held by the upper one of the pair of drawers 80 arranged at an uppermost portion and a lower portion of the housing 199 illustrated in FIG. 1A and FIG. 1B. In the present embodiment, it is assumed that the cartridges illustrated in FIG. 5A and FIG. 5B and the multiple cartridge trays illustrated in, for example, FIG. 1A and FIG. 1B are used as the multiple cartridges 10 and the multiple cartridge trays 20, respectively.

As illustrated in FIG. 10A, the carriage 50 can be moved by the conveyor 90 as illustrated in FIG. 1A and FIG. 1B in the X-axis direction and the Y-axis direction in the lower region of one of the multiple cartridges 10 and the cartridge tray 20. Firstly, as illustrated in FIG. 10, the carriage 50 moves to a position under the cartridge tray 20 that holds the cartridges 10 containing the medicine packages 2 to be picked up. In other words, the carriage 50 moves to a position where the upper reader unit 66a of the upper QR code reader 66 on the carriage 50 is approximately directly below the cartridge tray 20 and one of the multiple cartridges 10, and the QR code 6c on the medicine package 2 stored at the bottom of one of the multiple cartridges 10 can be scanned and read by the upper reader unit 66a of the upper QR code reader 66 through a scanning range 9 within the rectangular through opening 21 of the cartridge tray 20. The carriage 50 that is positioned as above reads the QR code 6c displayed on the medicine package 2, using the upper reader unit 66a of the upper QR code reader 66.

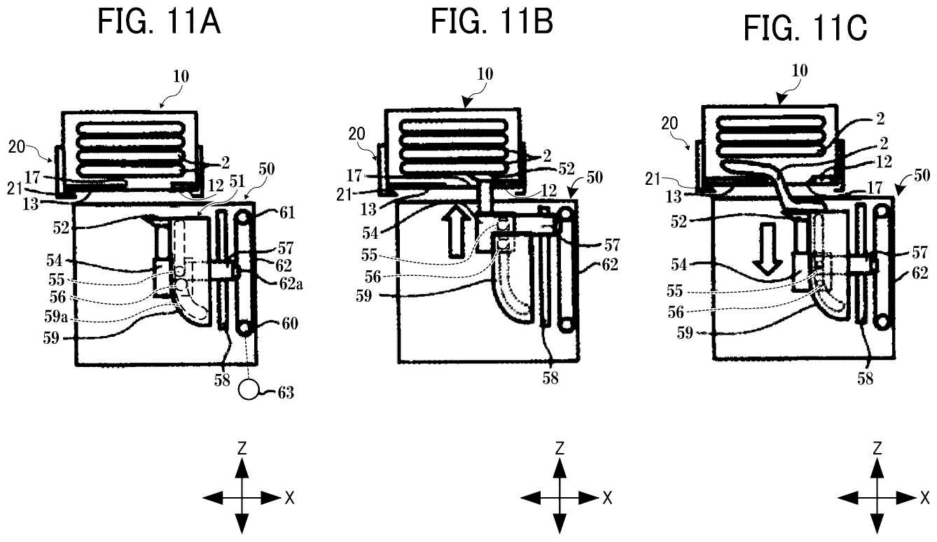

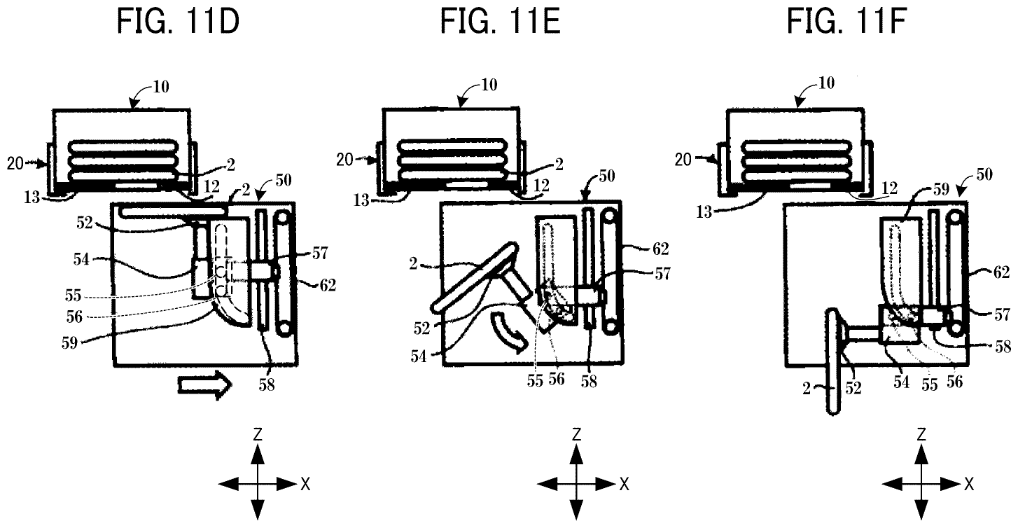

Subsequently, the carriage 50 is slightly moved by the conveyor 90 as illustrated in FIG. 1A and FIG. 1B from the position as illustrated in FIG. 10 to the right in the X-axis direction as illustrated in the 11A. As a result, the carriage 50 moves to a position where one of the multiple medicine packages 2 at the bottom can be picked up from the same cartridge 10. Under such conditions, the pair of suction pads 52 are positioned under the position of the top face of the pickup device, which indicates the position of the top face of the picking-up frame 50a of the carriage 50. Subsequently, as illustrated in FIG. 11B, the pair of suction pads 52 are moved upward by the operation of the drive motor 63, and enters from the pack pickup slot 17 between the right support portion 12 and the left support portion 13. Then, as soon as the pair of suction pads 52 contact one of the multiple medicine packages 2 at the bottom of one of the multiple cartridges 10, and the pair of suction pads 52 suck that medicine package 2. In so doing, the negative-pressure generator 45 has been driven in advance so as to generate a negative pressure, and can suck up the medicine package 2.

Subsequently, as illustrated in FIG. 11C, as the drive motor 63 is reversely operated, the pair of suction pads 52 move downward while sucking one of the multiple medicine packages 2 by the pair of suction pads 52, and the front end of one of the multiple medicine packages 2 is pulled out from one of the multiple cartridges 10. The front end of the medicine package indicates a side of the medicine package to be absorbed or sucked up by the pair of suction pads 52, and the same applies in the following description.

Subsequently, as illustrated in FIG. 11D, by the operation of the conveyor 90, the carriage 50 is moved in the X-axis direction, which is the lateral direction, and the rear end of one of the multiple medicine packages 2 is drawn out or picked up from one of the multiple cartridges 10. Immediately after that, as illustrated in FIG. 11E and FIG. 11F, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In such rotational operation, the guide axis 56 that is arranged on the suction-pad supporting member 54 moves along the guide groove 59a of the guide unit 59. Accordingly, the posture of one of the multiple medicine packages 2 can be changed from an approximately horizontal posture to an approximately vertical posture. The above series of operation in the above configuration may be achieved by a series of operations performed by a single drive motor 63.

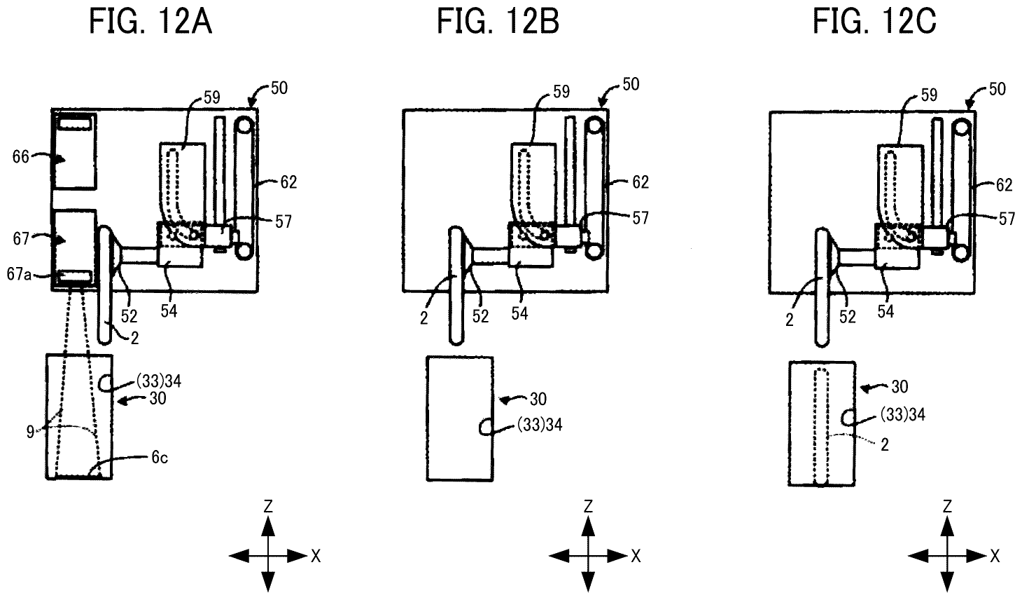

Then, as illustrated in FIG. 12A, the carriage 50 that includes the pair of suction pads 52 and holds one of the multiple medicine packages 2 in a substantially vertical posture is carried by the conveyor 90 to a predetermined position. Accordingly, the lower reader unit 67a of the lower QR code reader 67 in the carriage 50 comes to the predetermined position at which the QR code 6c is displayed at the bottom of predetermined one of the multiple subdivision boxes 34 or rooms 33 of one of the multiple medicine dispensing trays 30 moves to the scanning range 9, and the lower reader unit 67a reads the QR code 6c.

Subsequently, the carriage 50 is slightly moved by the conveyor 90 as illustrated in FIG. 1A and FIG. 1B from the position as illustrated in FIG. 12A to the right in the X-axis direction as illustrated in the 12B. As a result, the carriage 50 moves to a position where the picked-up medicine package 2 can be insertable into to a predetermined one of the multiple subdivision boxes 34 or rooms 33 of the same medicine dispensing tray 30. Then, the carriage 50 stops moving. Once the carriage 50 is carried to a position substantially directly above a predetermined one of the multiple subdivision boxes 34 or the rooms 33 of one of the multiple medicine dispensing trays 30 into which the picked-up medicine package 2 is insertable, the negative-pressure generator 45 is driven only for a short time in order to generate a positive pressure from the negative pressure. Accordingly, the pressurized air is blown from the pair of suction pads 52 to the medicine package 2. As a result, the suction holding of one of the multiple medicine packages 2 by the pair of suction pads 52 is released, and one of the multiple medicine packages 2 is inserted into a desired one of the multiple subdivision boxes 34 or a desired one of the multiple rooms 33 of the multiple medicine dispensing trays 30 (see, for example, FIG. 12C).

After the above-described operation is performed a plurality of times and a desired one of the multiple medicine packages 2 is inserted into one of the multiple rooms 33 that is at a predetermined position of one of the multiple medicine dispensing trays 30, one of the multiple medicine dispensing trays 30 is ejected to the outside of the medication support apparatus through the third gate 43 (see FIG. 1A and FIG. 1B), and is received by a staff or the like in a day-care center or nursing home or a medication assistant.

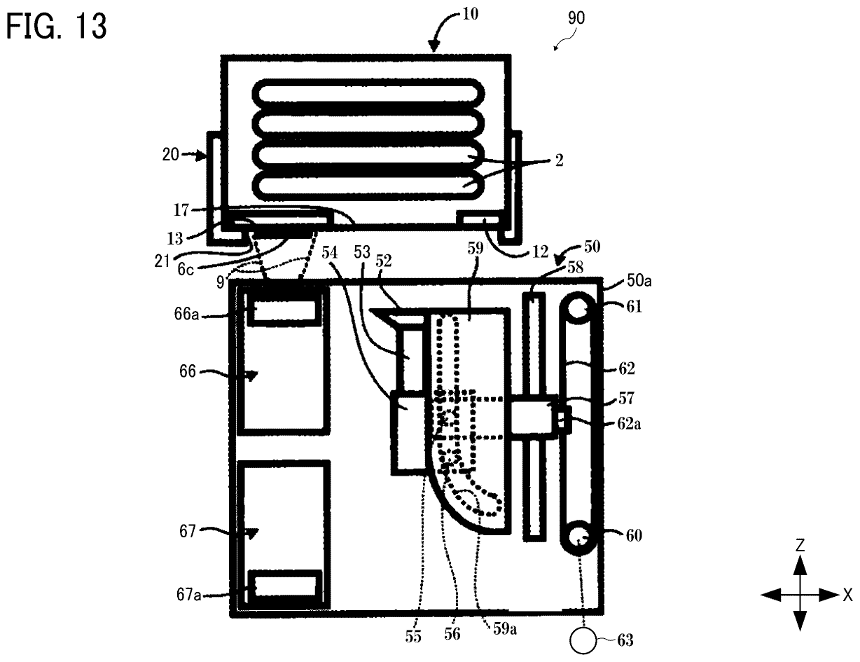

When the QR code 6c that is displayed on one of the multiple cartridges 10, as illustrated in FIG. 6A and FIG. 6B, is read by the upper reader unit 66a of the upper QR code reader 66 of FIG. 9A and FIG. 9B, as illustrated in FIG. 13, the QR code 6c that is displayed on the bottom wall of the left support portion 13 of one of the multiple cartridges 10 is read. More specifically, the carriage 50 is moved to a left position in the X-axis direction within the scanning range 9 in which the QR code 6c displayed on the bottom wall of the left support portion 13 of one of the multiple cartridges 10 can be scanned and read by the upper reader unit 66a of the upper QR code reader 66 in the carriage 50. The other operations of the carriage 50 are equivalent to the operations described above with reference to FIG. 11A to FIG. 12B.

As described above, in the present embodiment, when desired one of the multiple medicine packages 2 is picked up from one of the multiple cartridges 10, the carriage 50 is positioned or arranged under one of the multiple cartridges 10 and the cartridge tray 20, and such desired one of the multiple medicine packages 2 is taken out in the downward direction of one of the multiple cartridges 10. When one of the multiple medicine packages 2 is taken out from the lower side of one of the multiple cartridges 10 as described above, the next one of the multiple medicine packages 2 automatically moves downward or toward the pack pickup slot 17 due to the self weight of the movable board 16 and the multiple medicine packages 2 left in the cartridge 10. Due to such a configuration, the carriage 50 can perform the same operation with a relatively simple configuration regardless of the number of the multiple medicine packages 2 left in the cartridge 10.

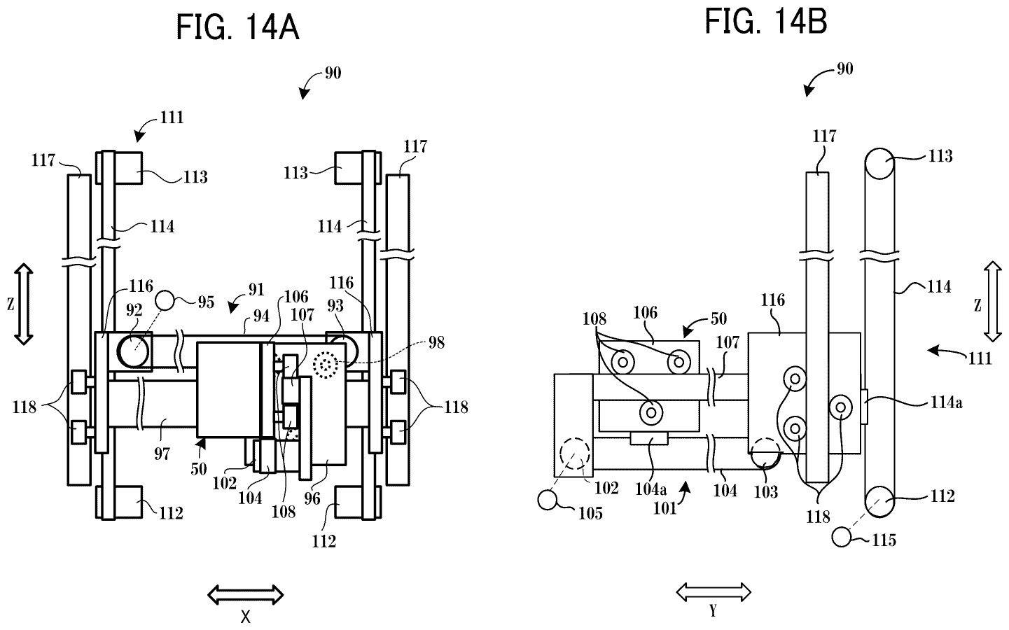

A configuration and operation of the conveyor 90 is described below with reference to FIG. 14A and FIG. 14B.

FIG. 14A is a front view of the conveyor 90 illustrating a schematic configuration of the conveyor 90.

FIG. 14B is a side view of the conveyor 90 illustrated in FIG. 14A.

As in the configuration or structure of the medicine dispensing apparatus 200 illustrated in FIG. 1A and FIG. 1B, the multiple cartridges 10 are aligned in a row on a plane under the medicine dispensing tray 30 in the Z-axis direction, and the medicine dispensing tray 30 is arranged at an uppermost portion of the housing 199 and further above the upper portions of the multiple cartridges 10. In view of these circumstances, the carriage 50 is configured to move in three directions of the X-axis direction, the Y-axis direction, and the Z-axis direction. As described above, the conveyor 90 moves the carriage 50 in the X-axis direction, the Y-axis direction, and the Z-axis direction in order to convey one of the multiple medicine packages 2 picked up from one of the multiple cartridges 10 by the carriage 50 and pass it to one of the multiple medicine dispensing trays 30.

The carriage 50 is moved in the X-axis direction by an X-axis direction conveyor 91, and the carriage 50 is moved in the Y-axis direction by a Y-axis direction conveyor 101. The carriage 50 is moved in the Z-axis direction by a Z-axis direction conveyor 111. These three conveyors have a similar configuration or structure.

The X-axis direction conveyor 91 includes an X-adaptor 96 attached to the carriage 50, an X-guide unit 97 that guides the carriage 50 in the X-axis direction through the X-adaptor 96, an endless belt 94 looped around a driving pulley 92 and a driven pulley 93, and a drive motor 95 used for the conveyance in the X-axis direction. The drive motor 95 is coupled to the driving pulley 92 through a driving force conveyor such as a gear or a belt. As illustrated in FIG. 14A, three rollers 98 are attached to the X-adaptor 96 so as to clamp the X-guide unit 97. Due to such a configuration, the X-adaptor 96 can roll over the X-guide unit 97. Note also that two of the three rollers 98 are hidden by the carriage 50 and invisible in FIG. 14A. The X-adaptor 96 is fixedly coupled to the endless belt 94 through a belt grip.

With the above-described configuration of the X-axis direction conveyor 91, as the drive motor 95 is driven, the driving force is conveyed to the endless belt 94 through the driving force conveyor and the driving pulley 92. Accordingly, the endless belt 94 rotates, and the carriage 50 moves in the X-axis direction parallel to the X-guide unit 97 together with the X-adaptor 96.

The Y-axis direction conveyor 101 includes a Y-adaptor 106 attached to the carriage 50, a Y-guide unit 107 that guides the carriage 50 in the Y-axis direction through the Y-adaptor 106, an endless belt 104 looped around a driving pulley 102 and a driven pulley 103, and a drive motor 105 used for the conveyance in the Y-axis direction. The drive motor 105 is coupled to the driving pulley 102 through a driving force conveyor such as a gear or a belt. Three rollers 108 are attached to the Y-adaptor 106 so as to clamp the Y-guide unit 107. Due to such a configuration, the Y-adaptor 106 can roll over the Y-guide unit 107. The Y-adaptor 106 is coupled and fixed to the endless belt 104 through a belt grip 104a.

With the above-described configuration of the Y-axis direction conveyor 101, as the drive motor 105 is driven, the driving force is conveyed to the endless belt 104 through the driving force conveyor and the driving pulley 102. Accordingly, the endless belt 104 rotates, and the carriage 50 moves in the Y-axis direction parallel to the Y-guide unit 107 together with the Y-adaptor 106.

The Z-axis direction conveyor 111 includes a pair of Z-adaptors 116 attached to both ends of the X-guide unit 97 in the X-axis direction, a pair of Z-guide units 117 that guides the carriage 50 in the Z-axis direction through the X-guide unit 97 and the pair of Z-adaptors 116, an endless belt 114 looped around a driving pulley 112 and a driven pulley 113, and a drive motor 115 used for the conveyance in the Z-axis direction. The drive motor 115 is coupled to the driving pulley 112 through a driving force conveyor such as a gear or a belt. In the Z-axis direction conveyor 111, the driving pulley 112, the driven pulley 113, and the endless belt 114 are arranged on both sides in the X-axis direction. The drive motor 115 is provided for only one of the pair of driving pulleys 112. Three rollers 118 are attached to the Z-adaptor 116 so as to clamp the Z-guide unit 117. Due to such a configuration, the Z-adaptor 116 can roll over the Z-guide unit 117. The pair of Z-adaptors 116 are coupled and fixed to the pair of endless belts 114 through a pair of belt grips 114a, respectively.

With the above-described configuration of the Z-axis direction conveyor 111, as the drive motor 115 is driven, the driving force is conveyed to the pair of endless belts 114 through the driving force conveyor and the driving pulley 112. Accordingly, the pair of endless belts 114 rotates, and the carriage 50 moves in the Z-axis direction parallel to the Z-guide unit 117 together with the X-guide unit 97 and the Z-adaptor 116.

In FIG. 14A and FIG. 14B, the carriage 50 is configured to move in the triaxial directions including the X-axis direction, the Y-axis direction, and the Z-axis direction. However, no limitation is indicated thereby. For example, when the multiple cartridges 10 are arranged above the carriage 50 and the multiple medicine dispensing trays 30 are arranged below the carriage 50, the carriage 50 only needs to move in the X-axis direction and the Y-axis direction. In such cases, the number of axes of motion can be reduced by one.

In the present embodiment, the QR code reader is divided into two sections including the upper QR code reader 66 provided with the upper reader unit 66a and the lower QR code reader 67 provided with the lower reader unit 67a. However, no limitation is indicated thereby, and one integrated QR code reader may be used.

As will be described later, the reading operation of the QR code 6c is controlled to automatically start upon detecting the storing of one of or both one of the multiple cartridges 10 and one of the multiple medicine dispensing trays 30. The reading operation of the QR code 6c may start immediately before one medicine pack is picked up from one of the multiple cartridges 10 or immediately before medicines are dispensed to one of the multiple medicine dispensing trays 30. Alternatively, the reading operation of the QR code 6c may start at any time specified by an operation made by a user. No limitation is intended thereby in terms of a method for implementation. In the present embodiment, the QR code 6c on the carriage 50 and the QR code 6c on each one of the multiple subdivision boxes 34 of the medicine dispensing tray 30 are read, and multiple items of information are stored. Then, such multiple items of information are used to make comparison when medicines are dispensed.

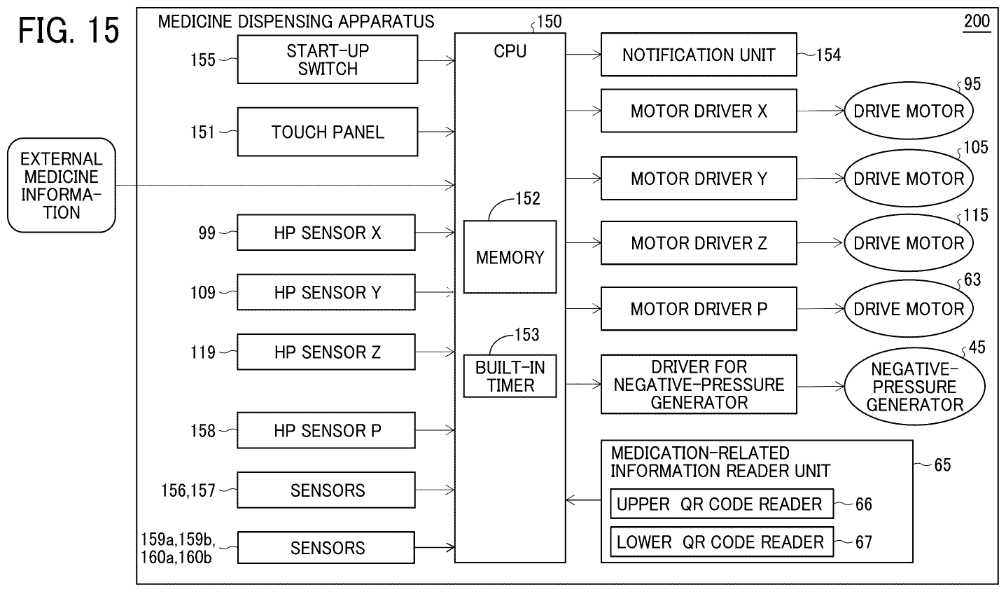

FIG. 15 is a diagram illustrating the control blocks of the medicine dispensing apparatus 200.

As illustrated in FIG. 15, the medicine dispensing apparatus 200 includes a central processing unit (CPU) that serves as a medicine dispensing controller 150 that controls the operation of, for example, the components or elements of the medicine dispensing apparatus 200. For example, the CPU may be provided with a built-in memory or a built-in timer. The CPU according to the present embodiment may provide notification to a staff or the like at a timing consistent with the program or may instruct the medicine dispensing apparatus 200 to perform particular operation, based on various kinds of input such as the inputs from a sensor as will be described later in detail.

The CPU may have, for example, a computing or control function, and a timer or clocking function. The memory 152 of the medicine dispensing controller 150 includes a random-access memory (RAM) that is referred to as a main memory, and a read-only memory (ROM). The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the multiple medicine packages 2 and the multiple rooms 33 or the multiple subdivision boxes 34 of one of the multiple medicine dispensing trays 30 allocated to each of the patients who take medicines, the data about the relation between the multiple medicine packages 2 and the multiple rooms 33 or the multiple subdivision boxes 34 of one of the multiple medicine dispensing trays 30 assigned to each one of the times of medication, or the data about the relation between the multiple medicine packages 2 and the multiple rooms 33 or the multiple subdivision boxes 34 of one of the multiple medicine dispensing trays 30 sorted according to the order in which medicines are to be taken.

The CPU has an input and output (I/O) port, and a touch panel 151 that serves as a user interface (UI) is electrically connected to that input and output port of the CPU. However, the user interface (UI) is not limited to the touch panel 151, and may be, for example, a combination of an input device and a display interface such as a combination of a keyboard and a light-emitting diode (LED) display.

The CPU has an input port, and a medicine dispensing tray sensor 156 that detects the type of medicine dispensing tray 30 stored in the medicine dispensing apparatus 200 or determines whether or not there is any medicine dispensing tray 30, and a cartridge sensor 157 that determines whether or not there is any one of the multiple cartridges 10 are electrically connected to the input port of the CPU. As various types of sensors, a pair of drawer gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU. The medicine dispensing tray sensor 156, the cartridge sensor 157, the pair of drawer gate opening and closing sensor 159a and 159b, and the pair of medicine dispensing tray gate opening and closing sensors 160a and 160b are illustrated in FIG. 15.

Moreover, a HP sensor 99 for a HP sensor X, which detects the home position (HP) of the X-axis direction conveyor 91 in the carriage 50, a HP sensor 109 for a HP sensor Y, which detects the home position (HP) of the Y-axis direction conveyor 101 in the carriage 50, and a HP sensor 119 for a HP sensor Z, which detects the home position (HP) of the Z-axis direction conveyor 111 in the carriage 50 are electrically connected to the input port of the CPU. Note that such a home position (HP) of each conveyance unit may be abbreviated to HP in the following description. Further, to the input port of the CPU, a home position (HP) sensor 158 for a HP sensor P, which detects the home positions (HP) of the pair of suction pads 52 of the suction device 51 in the carriage 50 is electrically connected.

The upper QR code reader 66 that is an example of the medication-related information reader unit 65 or an upper reader unit 66a and the lower QR code reader 67 that is an example of the medication-related information reader unit 65 or a lower reader unit 67a, each of which is provided for the carriage 50, are electrically connected to the input port of the CPU.

To the output port of the above CPU, the drive motor 95 for the X-axis direction conveyor 91, the drive motor 105 for the Y-axis direction conveyor 101, the drive motor 115 for the Z-axis direction conveyor 111, and the drive motor 63 used to change the posture or attitude of the pair of suction pads 52 are electrically connected to the input port of the CPU through various kinds of motor drivers X, Y, Z, and P, respectively. Moreover, to the output port of the above CPU, the negative-pressure generator 45 that is an example as an ejector valve and an actuator used for the negative-pressure generator is electrically connected through a driver used for a negative-pressure generator.

To the output port of the CPU, a notification unit may be electrically connected. The notification unit reports what sort of state or conditions the components or elements of the medicine dispensing apparatus 200 are in by means of, for example, the light emitted from a light-emitting diode (LED) and the sound or vibration including voice. Moreover, the notification unit may be provided with, for example, a loudspeaker or a light that indicates that the medicines are to be taken so that the staff or the like away from the medicine dispensing apparatus 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs 25al to 25d5 of the drawer 80 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit, the LEDs 25al to 25d5, the negative-pressure generator 45, the drive motor 63, the drive motor 95, the drive motor 105, the drive motor 115, or the multiple drives that correspond to the multiple LEDs.

The HP sensor 158 for the HP sensor P and the drive motor 63 that is driven through the motor driver P are used to control or drive the mechanism for moving the suction device to move upward and downward. The CPU according to the present embodiment has a function to execute various kinds of control operation as will be described later in detail in the following description or the flowchart of the controlling processes.

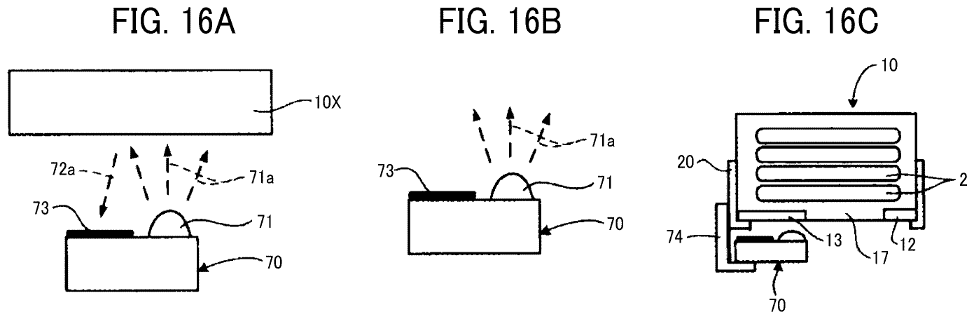

FIG. 16A to FIG. 16C are schematic diagrams of a cartridge sensor 70 that detects the attachment and detachment (or loading and unloading) of the cartridge 10.

As illustrated in FIG. 16A, a cartridge 10X that is an object to be detected is assumed, and such a cartridge is detected by an optical sensor such as a reflective photosensor that is an example of the container sensor. The cartridge sensor 70 that includes an optical sensor emits detection lights 71a from a light emitter 71, and receives reflection light 72a from that cartridge 10X at a photoreceptor 73 when the cartridge 10X is present. By so doing, the presence or absence of the cartridge 10X, which is an object to be detected, can be detected. By contrast, when there is no cartridge 10X, which is an object to be detected, as illustrated in FIG. 16B, the reflection light of the detection light 71a does not enter the photoreceptor 73. Due to such a configuration, the absence of the cartridge 10X, which is an object to be detected, can be detected.

As illustrated in FIG. 16C, the cartridge sensor 70 with an optical sensor is fitted and fixed to the cartridge tray 20, having, for example, a fitting plate 74 therebetween, to detect the attachment and detachment (or loading and unloading) of the cartridge 10. When the cartridge sensor 70 is arranged on the cartridge tray 20, the cartridge sensor 70 is fitted to the cartridge tray 20 using the fitting plate 74 so as not to interfere with, for example, the carriage 50 at the time of the QR-code reading operation using the upper reader unit 66a of the upper QR code reader 66.

The cartridge sensor 70 is not limited to the above optical sensor, and may use a distance sensor to check the changes in the distance from the cartridge 10. Due to such a configuration, the attachment or detachment (or loading and unloading) of the cartridge 10 can be detected. Alternatively, the cartridge sensor 70 may use a weight sensor to detect changes in the weight of the cartridge 10. Due to such a configuration, the attachment and detachment (or loading and unloading) of the cartridge 10 can be detected. The cartridge sensor 70 is not limited to the optical sensor, the distance sensor, or the weight sensor as described above, and may be, for example, a push switch that contacts the cartridge 10 to detect the attachment or detachment (or loading and unloading) of the cartridge 10.

An embodiment in which the attachment and detachment (or loading and unloading) of the cartridge 10 is detected using the cartridge sensor 70, which is composed of an optical sensor and is provided for each one of the cartridges 10, is described below.

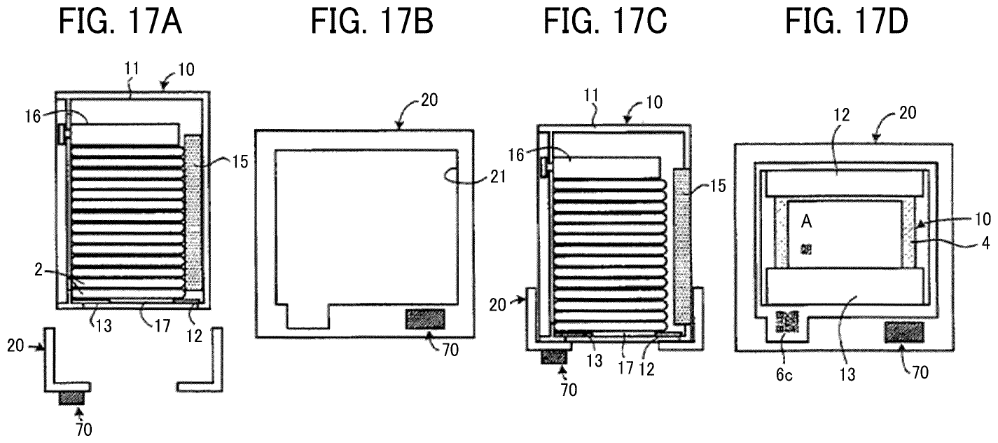

FIG. 17A and FIG. 17B are diagrams illustrating the cartridge tray 20 to which the cartridge 10 is not yet attached.

FIG. 17C and FIG. 17D are diagrams illustrating the cartridge tray 20 to which the cartridge 10 is attached.

FIG. 17A is a sectional view of the cartridge tray 20 to which the cartridge 10 is not yet attached and elements around the cartridge tray 20.

FIG. 17B is a bottom view of the cartridge tray 20 to which the cartridge 10 is not yet attached.

FIG. 17C is a sectional view of the cartridge 10, the cartridge tray 20 to which the cartridge 10 is not yet attached, and elements around the cartridge tray 20.

FIG. 17D is a bottom view of the cartridge tray 20 to which the cartridge 10 is attached.

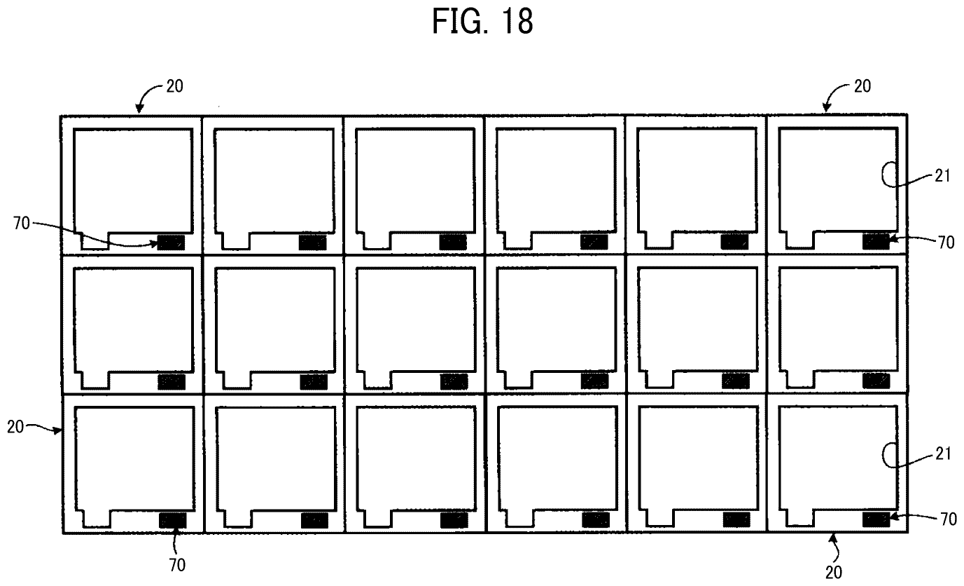

FIG. 18 is a bottom view of the multiple cartridge trays 20 on each of which the cartridge sensor 70 is mounted.

As illustrated in 17C and FIG. 17D, when the cartridge 10 is attached and set on the cartridge tray 20, the cartridge sensor 70 mounted on the outer bottom face of the cartridge tray 20 detects the bottom face of the cartridge 10. Accordingly, it is possible to monitor that the cartridge 10 is attached and set on the cartridge tray 20.

As described above, by arranging the cartridge sensor 70 on the cartridge tray 20, the loading or unloading of each cartridge 10 on the cartridge tray 20 can be checked. The multiple cartridge trays 20 may be combined together as illustrated in FIG. 18.

The procedure in the entire medication support in a case that the medication support apparatus according to the present embodiment is installed in a day-care center or nursing home is described below.

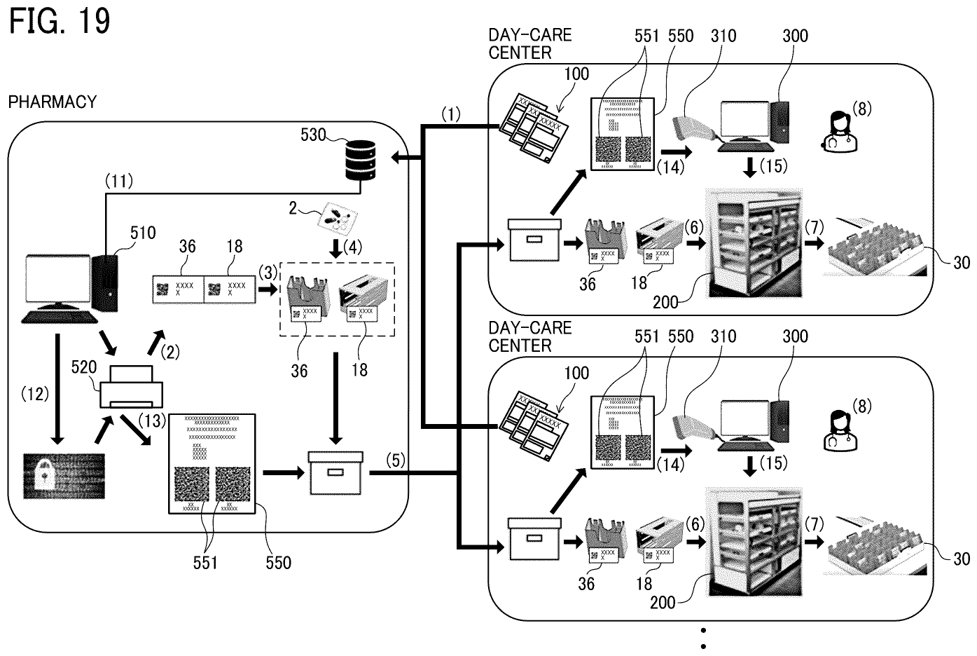

FIG. 19 is a diagram illustrating the flow of the procedure in an entire medication support system for helping a patient who takes medicines to take the medicines arranged by a pharmacy, in a day-care center or nursing home.

Typically, the medication support system illustrated in FIG. 19 includes an information processing system 500, which is installed in a facility such as a pharmacy, and the medicine dispensing system or medication support apparatus including the medicine dispensing apparatus 200 and a personal computer (PC) 300 installed in a facility such as a medical institution, day-care center, and nursing home where there are patients who take medicines. In the present embodiment, cases of day-care center or nursing home are described.

In the information processing system 500 installed in a pharmacy, an information processing device 510 including, for example, the PC 300, and a printer 520 that is an example of an image forming apparatus or image forming device are connected to each other and can communicate with each other. Moreover, the information processing system 500 in a pharmacy includes a receipt computer 530, and the information processing device 510 and the receipt computer 530 are connected to each other and can communicate with each other.

In a similar manner to typical desktop PCs, the information processing device 510 includes, for example, an input device such as a keyboard, a pointing device including a mouse, and a touch panel, a display unit such as a display, a processor such as a CPU, a memory such as a random-access memory (RAM), read-only memory (ROM), and solid-state drive (SSD), and a communication device that communicates with, for example, an external device such as the printer 520 and a device to be connected to and communicating through communication lines. Moreover, the information processing device 510 serves as a label generator that generates label data used to generate labels 18 and 36 to be attached to, for example, the medicine package 2, the cartridge 10, and the subdivision box 34 based on the prescription data file including the obtained medication-related information. The information processing device 510 serves as a coded-image generator that generates a coded image obtained by encoding the database file or medication schedule file that is medication-related information group, based on the prescription data file including the obtained medication-related information.

The printer 520 generates the labels 18 and 36 based on the label data and the coded image generated by the information processing device 510, or prints a coded image 551 on a recording medium 550, i.e., an invoice in the present embodiment. However, for example, its image forming method is not limited to any particular method. A label material on which no image has been printed is placed in the printer 520 as a recording material, and the printer 520 prints on a label material the print image indicated by the print data that is an example of label data and is sent from the information processing device 510. The recording medium 550 on which the coded image 551 obtained by encoding the database file is not yet printed is placed in the printer 520, and the printer 520 prints on the recording medium 550 the coded image 551 indicated by the print data sent from the information processing device 510.

In the first step, the prescription data including the obtained medication-related information such as the information about a prescription indicating, for example, the type of medicine or the time of medication, where the prescription may be a sheet medium or an electronic medium, and the information about the patient who takes the medicines, including, for example, the name of a day-care center or nursing home in which the patient who takes the medicines is residing and the residing floor is submitted from a medical institution, day-care center, or nursing home to a pharmacy. As a result, the data file of prescription data, which may be referred to as prescription data file in the following description, is stored in the receipt computer 530 in a pharmacy. In the second step, the information processing device 510 in a pharmacy extracts required data from the prescription data file, and prints the labels 18 and 36 using the printer 520.

In the third step, the labels 18 and 36 that are generated by the information processing system 500 are attached to the subdivision boxes 34 placed in the medicine dispensing tray 30 or the cartridges 10 placed in the medicine dispensing apparatus 200 installed in a day-care center or nursing home. The labels 18 and 36 are attached to the cartridges 10 or the subdivision boxes 34 as they are pasted or stuck to a certain position of the cartridges 10 or the subdivision boxes 34. However, how the labels 18 and 36 are attached is not limited to any particular method. For example, the labels 18 and 36 may be held in a label container arranged at a certain position of the cartridges 10 or the subdivision boxes 34.

In the fourth step, the medicines that correspond to the prescription data attached to the label are stored by a pharmacist in the cartridge 10 to which the label 18 that is generated by the information processing system 500 in a pharmacy is attached. In the fifth step, the cartridge 10 in which medicines such as bound packages of the medicine packages 2 (continuous packs 2A) are stored is conveyed and delivered to a day-care center or nursing home together with the subdivision box 34 to which the label 36 corresponding to the same prescription data is attached. Then, in the sixth step, the cartridges 10 and the subdivision boxes 34 that are conveyed to a day-care center or nursing home are placed in the medicine dispensing apparatus 200 installed in a day-care center or nursing home.

In the eleventh step, the information processing device 510 of the information processing system 500 in a pharmacy generates a database file that includes the medication schedule based on the prescription data file stored in the receipt computer 530, and stores the generated database file in the memory of the information processing device 510. This database file is data used to control the medicine dispensing apparatus 200 installed in a day-care center or nursing home, and serves as relation data that indicates a normal relation between the subdivision boxes 34 and the cartridges 10, which are placed in the medicine dispensing apparatus 200.

In the thirteenth step, the information processing device 510 in a pharmacy generates the coded image 551 obtained by encoding the database file, and prints the generated coded image 551 using the printer 520. In so doing, in the twelfth step, the database file may be encoded so as to firmly prevent the leakage of the personal information included in the database file about a plurality of patients who take medicines. In addition to the twelfth step, in the thirteenth step, the coded image 551 may be generated by encoding the encoded database file, and the generated coded image 551 may be printed using the printer 520.

The coded image 551 obtained by encoding the database file may be a one-dimensional coded image such as a bar code or a two-dimensional code such as a QR CODE. Alternatively, the coded image 551 may be a three-dimensional image. In the present embodiment, cases of a QR CODE that is an example of a two-dimensional coded image are described.

For example, the recording medium 550 on which the coded image 551 obtained by encoding the database file is printed may be an object as it is delivered from a pharmacy to a day-care center or nursing home, or may be an accompanying object delivered together with the object. In an example where the coded image 551 is printed onto an object as it is, the coded image 551 may be printed onto the cartridges 10 or the subdivision boxes 34 delivered from a pharmacy to a day-care center or nursing home or their packaging materials. In an example where the coded image 551 is printed onto an accompanying object, for example, the coded image 551 may be printed onto an accompanying document such as an invoice for the cartridges 10 or the subdivision boxes 34. The recording medium 550 is an example of an invoice.

As described above, in the fifth step, the recording medium 550 or invoice on which the coded image 551 obtained by encoding the database file is printed is conveyed and delivered to a day-care center or nursing home together with the cartridges 10 or the subdivision boxes 34. As a matter of course, the recording medium 550 on which the coded image 551 is printed may be sent through the mail separately from an object such as the cartridges 10 or the subdivision boxes 34.

The coded image 551 that is printed on the recording medium 550 conveyed to a day-care center or nursing home is scanned and obtained by the code scanner 310 that is an example of an imaging device and is coupled to the PC 300 installed in a day-care center or nursing home. Due to such a configuration, in step S14, the PC 300 reads and obtains the database file that is encoded by the coded image 551 from the data of the obtained coded image or captured image. When the database file is encoded, the PC 300 performs decryption for obtainment. Then, in step S15, the PC 300 sends the obtained database file to the medicine dispensing apparatus 200.

The medicine dispensing apparatus 200 performs, for example, an inspection as will be described later in detail and a medicine dispensing operation in which medicines are picked up from each one of the cartridges 10 prepared for each patient who takes medicines and the picked-up medicines are stored in the subdivision boxes 34 for the corresponding patient who takes medicines, based on the database file. In step S7, the multiple subdivision boxes 34 in which medicines are stored by the medicine dispensing apparatus 200 are placed in the medicine dispensing tray 30. In step S8, a personal care attendant who helps a person who takes medicines to takes the medicines carries that medicine dispensing tray 30 to the living site of each patient who takes medicines, and supports and help each patient who takes medicines to take the medicines in the subdivision boxes 34.

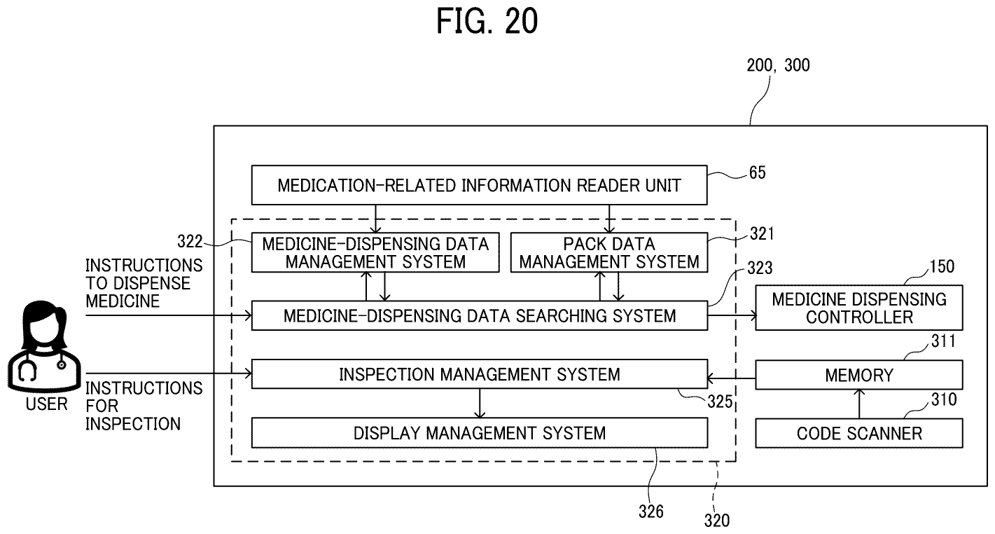

FIG. 20 is a diagram illustrating functional blocks of a medicine dispensing system or a medication support apparatus including the medicine dispensing apparatus 200 and the PC 300 in a day-care center or nursing home.

The medicine dispensing system according to the present embodiment such as the medication support apparatus includes the above-described medicine dispensing apparatus 200 and a personal computer (PC) 300 coupled to the medicine dispensing apparatus 200. Such coupling enables communication such as data transmission and data reception. The PC 300 serves as a host computer that manages and supports the medicine dispensing apparatus 200.

Elements that implement the functional blocks illustrated in FIG. 20 are provided for one of or both the medicine dispensing apparatus 200 and the PC 300 where appropriate. Most of the elements that implement the functional blocks illustrated in FIG. 20 is implemented by the PC 300, and some of the functions of, for example, the medication-related information reader unit 65 and the medicine dispensing controller 150 is implemented by the medicine dispensing apparatus 200. The PC 300 that implements an inspection management system 325 as will be described later in detail is an example of the checking apparatus that checks the relation between the subdivision boxes 34 and the cartridges 10, which are placed in the medicine dispensing apparatus 200. As a matter of course, the inspection management system 325 may be implemented by the medicine dispensing apparatus 200.

The PC 300 is provided with, for example, a control device, a processor, a memory, an input device, and an output device. The above control device of the PC 300 is provided with a central processing unit (CPU), and executes a program or gives instructions to other devices. The above processor of the PC 300 executes a program or performs computation. The above memory of the PC 300 is provided with, for example, a main memory and an auxiliary memory, and stores data such as programs or texts. The above input device of the PC 300 includes, for example, a mouse, a keyboard, a microphone, and sends data or instructions to the computer. The above output device of the PC 300 includes, for example, a display, a printer, a loudspeaker, and outputs the data output from the computer.

The PC 300 executes a management application 320 that is a computer program or application program, using a controller, a computer, or one or more processors, to implement the multiple functions of a pack data management system 321, a medicine-dispensing data management system 322, a medicine-dispensing data searching system 323, an inspection management system 325, and a display management system 326.

The pack data management system 321 manages the medication-related information on the medicine packages 2 to be dispensed by the medicine dispensing apparatus 200. More specifically, the pack data management system 321 obtains and manages the medication-related information read and obtained from the QR code 6c on the medicine packages 2 inside the cartridges 10 placed in the medicine dispensing apparatus 200, using the medication-related information reader unit 65 that includes the upper QR code reader 66 and the lower QR code reader 67 provided for the medicine dispensing apparatus 200. When one of the multiple medicine packages 2 picked up from one of the multiple cartridges 10 is held and is moved to the corresponding subdivision box 34 placed in the medicine dispensing apparatus 200, the medication-related information read and obtained from the QR code 6c on the subdivision boxes 34 may also be obtained and managed by the medication-related information reader unit 65.

As the carriage 50 is provided with the upper QR code reader 66 and the lower QR code reader 67 in the medicine dispensing apparatus 200, the name of a patient who takes medicines and the current position of the cartridge 10 in which the medicine package 2 to be taken by the patient who takes medicines is stored can be detected by the movement of the carriage 50 in the medicine dispensing apparatus 200. In other words, when the QR CODE on one of the multiple cartridges 10 is read by the upper QR code reader 66 to obtain the position coordinates of the cartridge 10 in the medicine dispensing apparatus 200 corresponding to the current position of the cartridge 10, the position coordinates of the carriage 50 corresponding to the current position of the cartridge 10 can be linked to the medication-related information read and obtained from the QR code 6c. In the position coordinates of the cartridge, for example, X, Y, and Z indicate the rows, columns, and stages, respectively.

In so doing, the medication-related information that is read by the upper QR code reader 66 or the lower QR code reader 67 may become erroneous information when the medicine package 2 is manually taken out from the cartridge 10 placed in the medicine dispensing apparatus 200 or when the cartridge 10 is replenished with the medicine package 2. In view of these circumstances, the medicine 3 may erroneously be dispensed when the medication-related information that is managed by the pack data management system 321 is not updated adequately.

In order to handle such a situation, at a prescribed timing for update, the medication-related information is read by the medication-related information reader unit 65 from the QR codes 6c on all the cartridges 10 placed in the medicine dispensing apparatus 200, and the medication-related information that is managed by the pack data management system 321 is updated. Such a prescribed timing for update may be, for example, a point in time after the power of the medicine dispensing apparatus 200 is turned on or turned off, a point in time when medicines are dispensed again after the medicine dispensing operation is once completed, and a point in time when there is a possibility that some of the cartridges 10 is replaced.

However, when the number of cartridges 10 placed in the medicine dispensing apparatus 200 is large, if the medication-related information of all the cartridges 10 is read every time during the medicine dispensing operation by the medicine dispensing apparatus 200, the length of time for the medicine dispensing operation by the medicine dispensing apparatus 200 increases excessively. In order to handle such a situation, when a medicine dispensing operation is performed by the medicine dispensing apparatus 200, for example, the medication-related information of only the cartridges 10 where the cartridge sensor 157 has detected attachment or detachment is read. By so doing, the length of time for the medicine dispensing operation by the medicine dispensing apparatus 200 can be prevented from increasing excessively.

The medicine-dispensing data management system 322 manages, for example, the medication-related information of the subdivision box 34 to which the medicine packages 2 to be dispensed by the medicine dispensing apparatus 200 is moved, the results of medicine dispensing, or the history of changes in, for example, what medicines are to be taken, which are changes from what are written in the prescription data due to, for example, the physical condition of a patient who takes medicines. More specifically, the medication-related information that is read and obtained from the QR code 6c on the subdivision boxes 34, which are placed in the medicine dispensing apparatus 200, is obtained and managed using the medication-related information reader unit 65 that includes the upper QR code reader 66 and the lower QR code reader 67 provided for the medicine dispensing apparatus 200.

In the medicine dispensing apparatus 200, the carriage 50 is provided with the upper QR code reader 66 and the lower QR code reader 67. Due to such a configuration, the current position of the subdivision box 34 to which the medicine package 2 is to be conveyed can be detected by the movement of the carriage 50 in the medicine dispensing apparatus 200. In other words, when the QR code 6c on the subdivision box 34 is read by the lower QR code reader 67 to obtain the position coordinates of the subdivision box 34 in the medicine dispensing apparatus 200 corresponding to the current position of the subdivision box 34, the position coordinates of the carriage 50 corresponding to the current position of the subdivision box 34 can be linked to the medication-related information read and obtained from the QR code 6c. In the position coordinates of the subdivision box, for example, X, Y, and Z indicate the rows, columns, and stages, respectively.

When the subdivision boxes 34 placed in the medicine dispensing apparatus 200 are taken out, replenished, or moved, the medication-related information or the coordinate data that is read by the upper QR code reader 66 or the lower QR code reader 67 may become erroneous information. In order to handle such a situation, in a similar manner to the pack data management system 321 as described above, it is desired that the position data or the medication-related information that is managed by the medicine-dispensing data management system 322 be updated as necessary.

When instructions to dispense medicine are given from a user, the medicine-dispensing data searching system 323 sends a data query to the pack data management system 321 and the medicine-dispensing data management system 322. The medicine-dispensing data searching system 323 associates the medicine packages 2 inside the cartridges 10 placed in the medicine dispensing apparatus 200 with the subdivision boxes 34 placed in the medicine dispensing apparatus 200, based on the data received from the pack data management system 321 and the medicine-dispensing data management system 322. For example, the medication-related information managed by the pack data management system 321, which is the medication-related information read and obtained from the QR code 6c on the medicine packages 2 inside the cartridges 10, is compared with the medication-related information managed by the medicine-dispensing data management system 322, which is the medication-related information read and obtained from the QR code 6c on the subdivision boxes 34, to search for a combination where the medication-related information such as the name of a patient who takes medicines and the times of medication matches, and an association is formed.

The medicine-dispensing data searching system 323 sends the result of the above comparison and associating process to the medicine dispensing controller 150 of the medicine dispensing apparatus 200. Due to such a configuration, the medicine dispensing controller 150 can figure out to which one of the subdivision boxes 34 the medicine packages 2 inside the cartridges 10 placed in the medicine dispensing apparatus 200 is to be conveyed, and can convey the medicine packages 2 inside the cartridges 10 to corresponding ones of the subdivision boxes 34.

If there are some cartridges 10 or subdivision boxes 34 that cannot be associated as described above in the medicine-dispensing data searching system 323, in the medicine dispensing apparatus 200, some of the medicine packages 2 inside such a cartridge 10 cannot be dispensed or some of the medicine packages 2 cannot be placed in any one of the subdivision boxes 34. In order to prevent such a situation, in a comparative example, a checking operation is made for all the cartridges 10 and the subdivision boxes 34 that are sent from a pharmacy and delivered to a day-care center or nursing home. Such a checking operation is made before those cartridges or subdivision boxes are placed in the medicine dispensing apparatus 200, and a use has to perform a visual check of the relation. Such a visual check by a user is very annoying, and places a heavy load on the user.

In order to reduce such a load of checking operation, the PC 300 implements the inspection management system 325. When instructions for inspection are given from a user, the inspection management system 325 performs an inspection to check the relation between the cartridges 10 and the subdivision boxes 34 placed in the medicine dispensing apparatus 200.

More specifically, first of all, the coded image 551 that is printed on the recording medium 550 or invoice, which is delivered from a pharmacy together with the cartridges 10 and the subdivision boxes 34, is scanned and obtained by the code scanner 310 of the PC 300. Due to such a configuration, the PC 300 reads and obtains the database file or relation data that is encoded by the coded image 551 from the data of the obtained coded image. When the database file is encoded, the PC 300 performs decryption for obtainment. Then, the PC 300 stores the obtained database file in the memory 311.

Subsequently, the subdivision boxes 34 and the cartridges 10 delivered from a pharmacy are placed in the medicine dispensing apparatus 200. When instructions for inspection are given, the inspection management system 325 sends a data query to the medicine-dispensing data searching system 323. In response to this query, the medicine-dispensing data searching system 323 sends a data query to the pack data management system 321 and the medicine-dispensing data management system 322. Due to such a configuration, the medicine-dispensing data searching system 323 obtains the medication-related information managed by the pack data management system 321, which is the medication-related information read and obtained from the QR code 6c on the medicine packages 2 inside the cartridges 10, and the medication-related information managed by the medicine-dispensing data management system 322, which is the medication-related information read and obtained from the QR code 6c on the subdivision boxes 34, and send those items of information to the inspection management system 325.

Then, the inspection management system 325 compares the database file stored in the memory 311, which is relation data, with the medication-related information obtained from the pack data management system 321, which is the medication-related information of the medicine packages 2 inside the cartridges 10, and the medication-related information managed by the medicine-dispensing data management system 322, which is the medication-related information of the subdivision boxes 34.

The inspection management system 325 can identify the relation between the cartridges 10 and the subdivision boxes 34, which are placed in the medicine dispensing apparatus 200, based on the medication-related information obtained from the pack data management system 321 and the medication-related information managed by the medicine-dispensing data management system 322. The inspection management system 325 can determine whether the relation between the cartridge 10 delivered from a pharmacy and the subdivision box 34 is normal based on the database file stored in the memory 311. By making those comparisons as described above, whether the relation between the cartridges 10 and the subdivision boxes 34, which are delivered from a pharmacy and placed in the medicine dispensing apparatus 200, is a normal relation based on the database file that is read from the coded image 551 on the invoice, i.e., the recording medium 550 can be determined.

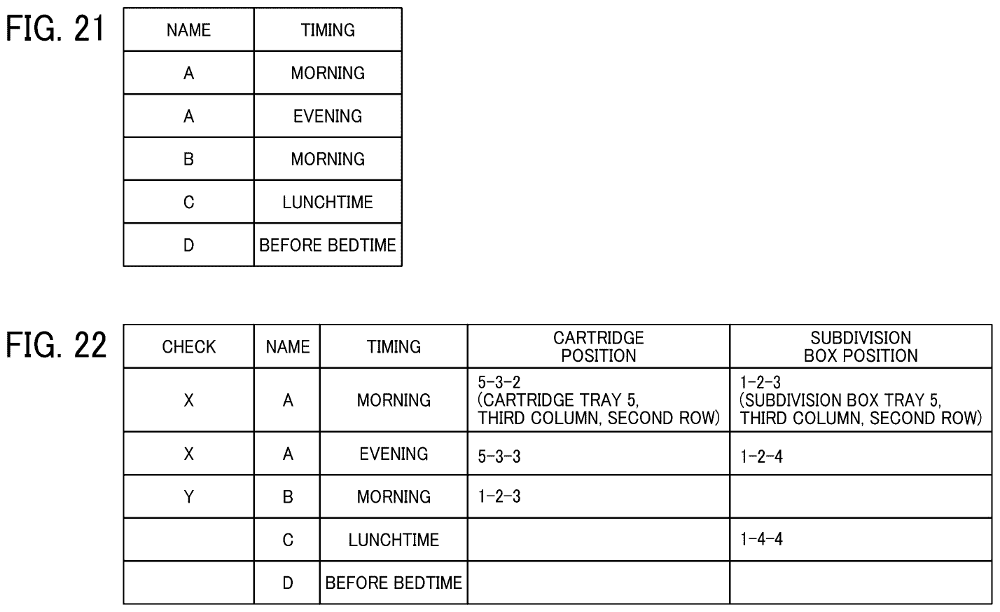

FIG. 21 is a table depicting the delivery data obtained by the inspection management system 325 from a database file of the memory 311.

The inspection management system 325 makes a comparison as described above based on this delivery data. In a similar manner to the medication-related information read and obtained from the QR code 6c on the subdivision boxes 34 or the cartridges 10, the database file includes the medication-related information such as the times of medication and the name of a patient who takes medicines, which is identifying information. In FIG. 21, delivery data in which the name of a patient who takes medicines and the times of medication are associated with each other is used. However, no limitation is indicated thereby. For example, different kinds of data may be used, or other various kinds of data may be included in the delivery data.

FIG. 22 is a table indicating the result of the inspection performed by the inspection management system 325.

For each item of the delivery data such as the name of a patient who takes medicines and the times of medication, the inspection management system 325 generates inspection data to which the result of the comparison is added as a comparison result. In addition to the result of the comparison, the data of the positions the cartridges 10 and the data of the positions of the subdivision boxes 34 are added to the inspection data illustrated in FIG. 22. Each one of the positions of the cartridges 10 and the subdivision boxes 34 is managed by a tray number, and a column number and row number inside a tray. In FIG. 22, the cartridge position “5-3-2” in the first row of the table indicates the cartridge tray No. 5 in the third column, in the second row. The data of the positions of these cartridges 10 and the data of the positions of these subdivision boxes 34 are obtained from the medicine-dispensing data searching system 323. It is to be noted that other kinds of items of information may be included in the inspection data.

When the medication-related information read and obtained from the QR code 6c are included in the delivery data for both the cartridges 10 and the subdivision boxes 34, which are delivered from a pharmacy and placed in the medicine dispensing apparatus 200, “X” that indicates normality is added to an item of the result of the comparison, and the information about the position of the cartridge 10 and the position of the subdivision box 34 is added. “Y” is added to an item of the result of the comparison when medication-related information read and obtained from the QR code 6c on the cartridges 10 matches the delivery data but the other item of information does not match, and the information about the position of the cartridge 10 is added. When only the medication-related information read and obtained from the QR code 6c on the subdivision boxes 34 matches the delivery data, the item of the result of the comparison is left blank indicating that the result of the comparison is abnormal, and the information about the position of the subdivision box 34 is added. When both the medication-related information read and obtained from the QR code 6c on the cartridges 10 and the medication-related information read and obtained from the QR code 6c on the subdivision boxes 34 does not match the delivery data, the item of the result of the comparison is left blank indicating that the result of the comparison is abnormal.

When the medication-related information read and obtained from the QR code 6c on the subdivision boxes 34 is not yet checked against the delivery data and the medication-related information read and obtained from the QR code 6c on the cartridges 10 matches the delivery data, a result of comparison “Y” is output. Due to such a configuration, a user can confirm that at least the cartridges 10 are delivered normally. Accordingly, for example, even if the subdivision boxes 34 are not yet attached or the attached subdivision boxes 34 are used for different processes, a user can check whether the cartridges 10 are delivered normally.

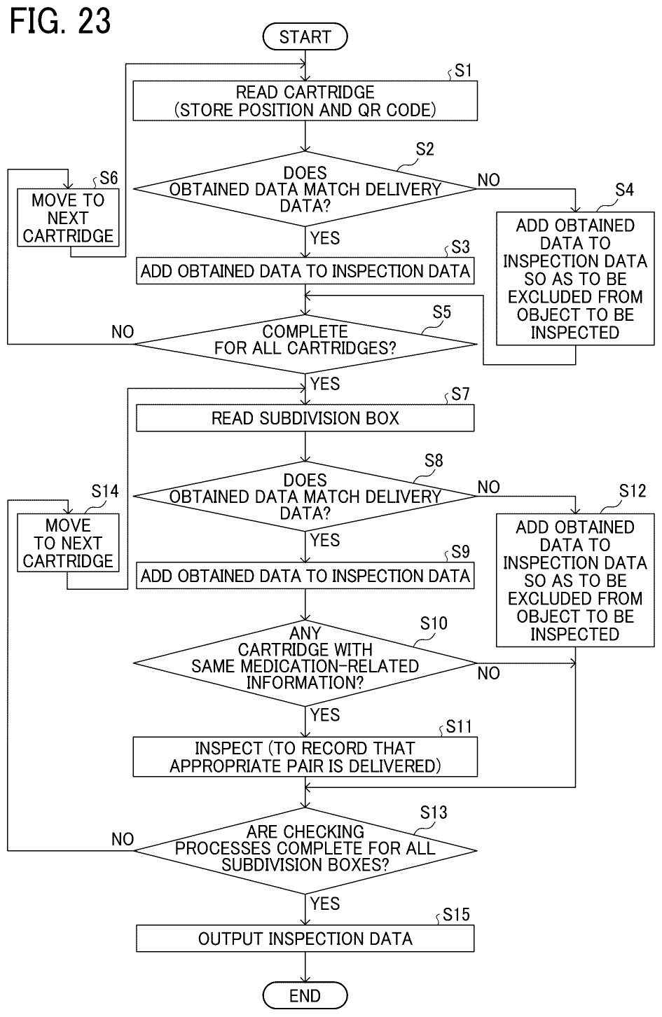

FIG. 23 is a flowchart of an operation in which inspection is performed by the inspection management system 325.

As described above, the database file, which is delivered from a pharmacy together with the cartridges 10 and the subdivision boxes 34 and is read from the coded image 551 on the recording medium 550, i.e., an invoice, is stored in the memory 311 in advance. The subdivision boxes 34 and the cartridges 10 delivered from a pharmacy are placed in the medicine dispensing apparatus 200 in advance.

When instructions for inspection are given, firstly, the inspection management system 325 queries the medicine-dispensing data searching system 323 for the data about the cartridges 10. In order to achieve such functions, the medicine-dispensing data searching system 323 queries the pack data management system 321 for the data about the cartridges 10. In response to this query, in step S1, the pack data management system 321 moves the carriage 50 provided with the upper QR code reader 66 to the first one of the cartridges 10 to be checked, and causes the upper QR code reader 66 to read the QR code 6c on the medicine packages 2 inside the first one of the cartridges 10 to be checked. Accordingly, the medication-related information of the first one of the cartridges 10 to be checked is obtained by the inspection management system 325 through the medicine-dispensing data searching system 323 together with the information about the position of the first one of the cartridges 10 to be checked, which are indicated by the information about the coordinates of the carriage 50.

Subsequently, in step S2, the inspection management system 325 refers to the delivery data that includes the name of a patient who takes medicines and the times of medication and is obtained from the database file stored in the memory 311 to determine any item of the obtained medication-related information of the first one of the cartridges 10 to be checked, which includes the name of a patient who takes medicines and the times of medication, matches the delivery data. When some items of the obtained medication-related information of the first one of the cartridges 10 to be checked, which includes the name of a patient who takes medicines and the times of medication, match the delivery data, in step S3, the inspection management system 325 adds the data of the obtained position of the cartridge to inspection data.

By contrast, when none of the items of the obtained medication-related information of the first one of the cartridges 10 to be checked, which includes the name of a patient who takes medicines and the times of medication, matches the delivery data in step S2, in step S4, the inspection management system 325 adds the medication-related information of the first one of the cartridges 10 to be checked or the information about the position of the cartridge 10 to the inspection data as abnormal data so as to be excluded from the object to be inspected. When the obtained information about the cartridges to be excluded from the object to be inspected or the cartridges that have been determined to be abnormal is added to the inspection data, preferably, at least the data that could be used as personal information such as the name of the patient who takes the medicines included in the medication-related information should be processed or modified such that the personal information cannot be identified. Regarding the information about the positions of the cartridges to be excluded from the object to be inspected, it should be added to the inspection data in an identifiable manner.

These checking processes in steps S1 to S4 as above for the cartridges are sequentially performed for all the cartridges 10 through step S6 after NO in step S5. When the checking processes for the cartridges are complete for all the cartridges 10 (YES in step S5), the inspection management system 325 queries the medicine-dispensing data searching system 323 for the information about the subdivision boxes 34. By so doing, the medicine-dispensing data searching system 323 queries the medicine-dispensing data management system 322 for the data about the subdivision boxes 34. In response to this query, in step S7, the medicine-dispensing data management system 322 makes the carriage 50 provided with the lower QR code reader 67 moved to the first one of the subdivision boxes 34 to be checked, and the QR code 6c on the first one of the subdivision boxes 34 to be checked is read by the lower QR code reader 67. Due to such a configuration, the read medication-related information of the first one of the subdivision boxes 34 to be checked is obtained by the inspection management system 325 through the medicine-dispensing data searching system 323, together with the information about the position of the first one of the subdivision boxes 34 to be checked, which are indicated by the information about the coordinates of the carriage 50.

Subsequently, in step S8, the inspection management system 325 refers to the delivery data that includes the name of a patient who takes medicines and the times of medication and is obtained from the database file stored in the memory 311, and determines any item of the obtained medication-related information of the first one of the subdivision boxes 34 to be checked, which includes the name of a patient who takes medicines and the times of medication, matches the inspection data. When some items match the inspection data, in step S9, the inspection management system 325 adds the obtained information about the position of the subdivision box 34 to the inspection data. Subsequently, in step S10, whether the information about the position of the cartridge 10 for the matched medication-related information is added is checked. When the information about the position of the cartridge 10 is added, in step S11, data indicating that the result of comparison is normal is added to the inspection data.

By contrast, when none of the items matches the inspection data in step S8, in step S12, the inspection management system 325 adds the medication-related information of the first one of the subdivision boxes 34 to be checked or the information about the position of the subdivision box 34 to the inspection data as abnormal data so as to be excluded from the object to be inspected. When the obtained information about the subdivision boxes to be excluded from the object to be inspected or the subdivision boxes that have been determined to be abnormal is added to the inspection data, preferably, at least the data that could be used as personal information such as the name of the patient who takes the medicines included in the medication-related information should be processed or modified such that the personal information cannot be identified. Regarding the information about the position of the subdivision boxes to be excluded from the object to be inspected, it should be added to the inspection data in an identifiable manner.

These checking processes in steps S7 to S12 as above for the subdivision boxes are sequentially performed for all the subdivision boxes 34 through step S14 after NO in step S13. When the checking processes for the subdivision boxes are complete for all the subdivision boxes 34 (YES in step S13), the inspection management system 325 terminates the inspection, and sends the inspection data to the display management system 326. By so doing, in step S14, the display management system 326 outputs the inspection data to the display of the PC 300.

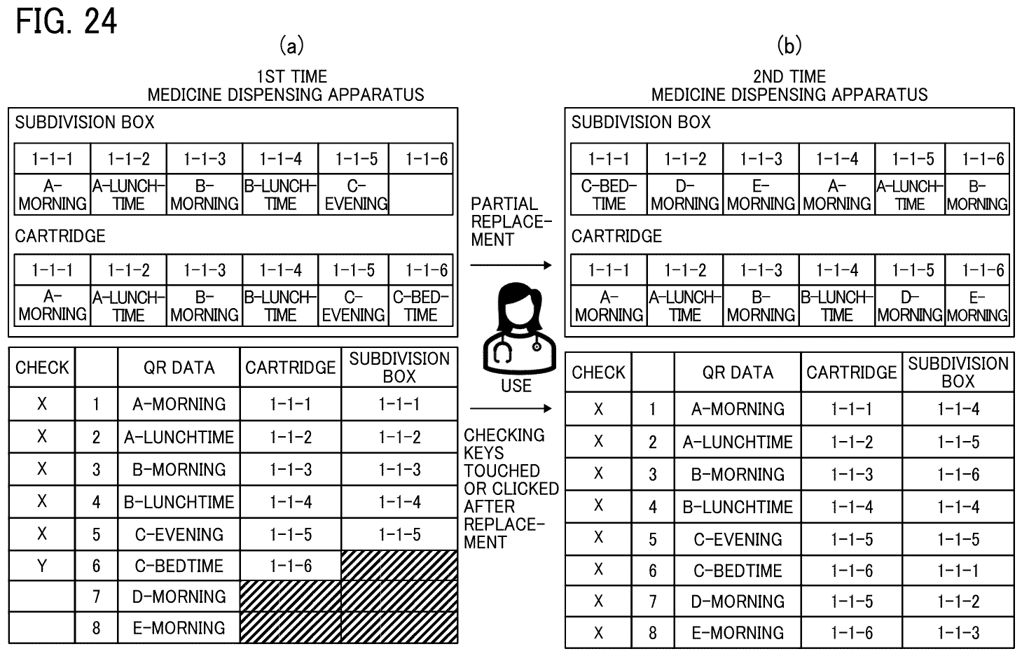

There are some cases in which the number of the cartridges 10 that have been delivered and the number of the subdivision boxes 34 that have been delivered are greater than the number of the cartridges 10 that can be placed in the medicine dispensing apparatus 200 and the number of the subdivision boxes 34 that can be placed in the medicine dispensing apparatus 200, respectively. An example of inspection in such cases is described with reference to FIG. 24. In the example described with reference to FIG. 24, the number of the cartridges 10 that can be placed in the medicine dispensing apparatus 200 and the number of the subdivision boxes 34 that can be placed in the medicine dispensing apparatus 200 are both six, and the number of the cartridges 10 that have been delivered and the number of the subdivision boxes 34 that have been delivered are both eight.

Firstly, some of the cartridges 10 that have been delivered and some of the subdivision boxes 34 that have been delivered are placed in the medicine dispensing apparatus 200, and the inspection is performed for the first time. In the inspection for the first time, as illustrated in an upper portion of (a) of FIG. 24, six cartridges and five subdivision boxes are placed in the medicine dispensing apparatus 200. In the inspection for the first time, inspection data is obtained as illustrated in a lower portion of (a) of FIG. 24. In such inspection data, five combinations (relations) of information about the cartridges 10 and the subdivision boxes 34 are normal. The shaded areas in (a) of FIG. 24 indicate that position data is not successfully obtained in the inspection for the first time. After the inspection for the first time, the inspection management system 325 holds the inspection data in the inspection for the first time.

After the inspection for the first time is completed, as illustrated in an upper portion of (b) of FIG. 24, the cartridges 10 and the subdivision boxes 34 that are placed in the medicine dispensing apparatus 200 are replaced with remaining ones of the cartridges 10 that are not yet inspected and remaining ones of the subdivision boxes 34 that are not yet inspected. When instructions for the inspection for the second time are given, the inspection management system 325 performs the inspection, and adds the result of the inspection to the inspection data in the inspection for the first time. In response to such an operation, inspection data is obtained as illustrated in a lower portion of (b) of FIG. 24. In such inspection data, all the eight combinations (relations) of information about the cartridges 10 and the subdivision boxes 34 are normal.

When the information about the position of the cartridge 10 is obtained in the inspection for the first time and the information about the position of the subdivision box 34 is obtained in the inspection for the second time, the checking processes for the cartridge are completed when the inspection for the first time is completed, and the checking processes for a combination of the cartridge 10 and the subdivision box 34 are completed after the inspection for the second time is completed (see C-BEDTIME in FIG. 24, where C includes the name of a patient who takes medicines and BEDTIME indicates the times of medication is before going to bed). The same applies to the equivalent operations given below. When the information about the position of the subdivision box 34 and the position of the cartridge 10 could not successfully be obtained in the inspection for the first time but the information about both the position of the subdivision box 34 and the position of the cartridge 10 is successfully obtained in the inspection for the second time, the checking processes for a combination of the cartridge 10 and the subdivision box 34 are completed after the inspection for the second time is completed (see D-MORNING and E-MORNING in FIG. 24).

When the information about both the position of the subdivision box 34 and the position of the cartridge 10 is successfully obtained in both the inspection for the first time and the inspection for the second time and the position that is obtained in the inspection for the second time is different from the position that is obtained in the inspection for the first time, the data is overwritten with the information about the position obtained in the inspection for the second time (see A-MORNING, A-LUNCHTIME, and B-MORNING in FIG. 24 for the information about the position of the subdivision boxes 34). When the information about both the position of the subdivision box 34 and the position of the cartridge 10 is successfully obtained in the inspection for the first time but the information about one of or both the position of the subdivision box 34 and the position of the cartridge 10 could not successfully be obtained in the inspection for the second time, it is assumed that the checking processes for a combination of the cartridge 10 and the subdivision box 34 are completed (see C-EVENING in FIG. 24).

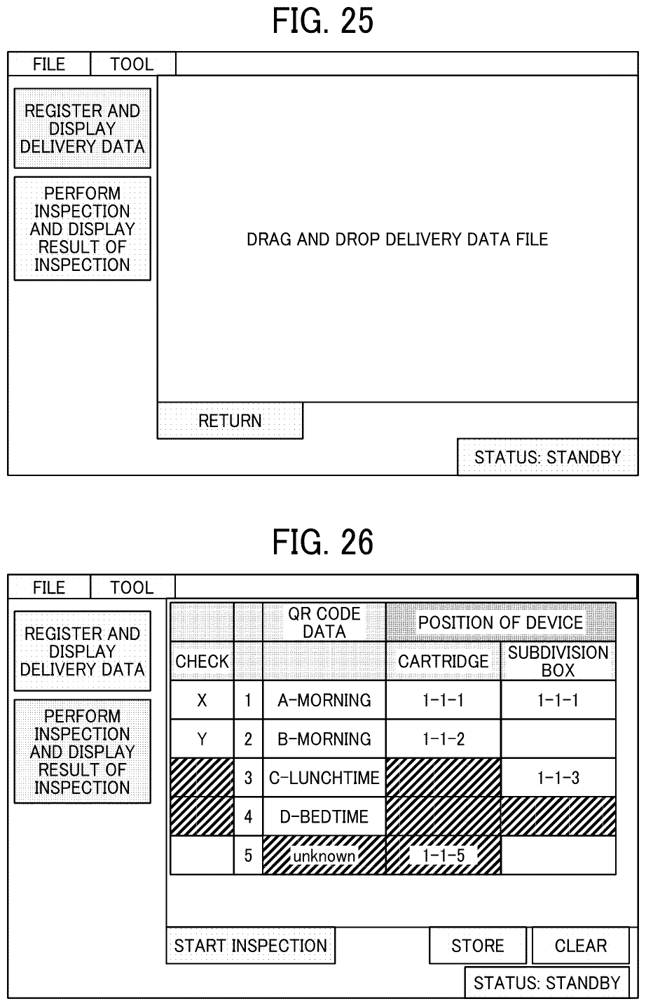

FIG. 25 is a diagram illustrating what is displayed by the management application 320 when a database file or delivery data file is read by the inspection management system 325.

For example, the database file that is read from the coded image 551 on the recording medium 550, i.e., an invoice, using the code scanner 310 of the PC 300 is dragged and dropped using a computer mouse on the screen as illustrated in FIG. 25 so as to be read by the inspection management system 325. In response to such an operation, the inspection management system 325 extracts the data of the names of patients who take medicines and the times of medication from the database file, and generates delivery data and inspection data.

FIG. 26 is a screen display that is displayed when inspection is performed or the result of inspection is displayed.

As the inspection data such as the delivery data, the result of comparison, and the position data is displayed on such a screen, a user can check, for example, the information about the patient who takes the medicines, the information about the positions of the cartridges 10 or the subdivision boxes 34, and the result of comparison. Before the inspection is performed, the delivery data is displayed. After the inspection is performed, for example, the result of comparison and the position data are displayed.

Commands for executing the inspection are carried out by clicking or tapping an inspection start key on the screen. After the inspection is completed, the inspection data is displayed. When the inspection is to be executed continuously, the inspection start key is clicked or tapped again. When a clear key is clicked or tapped on the screen, the inspection data is deleted. When a store key on the screen is clicked or tapped after the inspection is executed, the inspection data can be stored as electronic data. The file format of the electronic data is, for example, portable document format (PDF) or comma separated value (CSV) format.

On the display after the inspection is executed, it is desired that a user be informed about cells where the inspection is not successfully done by highlighting the background of the cells that indicate the result of the comparison or the cells without the information about the positions of the cartridge 10 or the information about the subdivision box 34 with, for example, hatching in red or solid fills. When there are some cartridges or subdivision boxes that do not correspond to the delivery data, the information about the positions of those cartridges or subdivision boxes is written in the inspection data. However, it is desired that those cartridges or subdivision boxes be, for example, highlighted with its background color displayed in red. In so doing, as described above, items of information should be expressed in such a manner that any specific individual cannot be traced in order to protect the personal information, and for example, it is desired that those items be highlighted with its background color displayed in red. Due to such a configuration, a user can be notified of errors in delivery without disclosing the personal information.

The embodiments described above are given as an example, and unique advantageous effects are achieved for each of the following modes given below.

### First Aspect

A checking apparatus such as the PC 300 checks a relation between a medicine placement unit and one of a medicine package and a container placed in a medication support apparatus such as the medicine dispensing apparatus or the medicine dispensing system that conveys and dispenses a medicine package stored in a container such as the cartridge 10 to a corresponding medicine placement unit such as the subdivision box 34. The checking apparatus includes a comparison data acquisition unit such as the code scanner 310 to obtain comparison data such as the database file, an inspection unit such as the inspection management system 325 to compare the comparison data obtained by the comparison data acquisition unit with first data such as the medication-related information read by a first data reader such as the upper QR code reader 66 from a first data retaining medium such as the QR code 6c disposed on a container or the medicine package stored in the container and second data such as the medication-related information read by a second data reader such as the lower QR code reader 67 from a second data retaining medium such as the QR code 6c disposed on the medicine placement unit, and a comparison-result output unit such as the display management system 326 to output a result of comparison performed by the inspection unit.

According to the present aspect, the first data is read by the first data reader from the first data retaining medium disposed on the container or the medicine package stored in the container, and the second data is read by the second data reader from the second data retaining medium disposed on the medicine placement unit. Then, the result of the comparison performed between the comparison data obtained by the comparison data acquisition unit and the read first and second data is output by the comparison-result output unit.

The first data and the second data are satisfactory as long as they can be used to determine whether the relation between the medicine packages or the containers that correspond to the first data and the medicine placement units that correspond to the second data is normal based on the comparison with the comparison data. For example, when the medicine packages with varying patients who take medicines are conveyed to the medicine placement units that correspond to those varying patient who takes medicines, respectively, and identifying information such as the name of a patient who takes medicines is used as the comparison data, the identifying information such as the name of a patient who takes medicines is adopted as the first data and the second data. For example, when the medicine packages with varying times of medication are conveyed to the medicine placement units that correspond to those varying times of medication, respectively, and the times of medication are used as the comparison data, the information about the times of medication is used as the first data and the second data.

According to the present aspect, whether the relation between the medicine placement unit and the medicine package or the container placed in the medication support apparatus is normal can be determined based on the result of comparison output from the inspection unit. For example, when both the first data and the second data are successfully checked against the comparison data obtained by the comparison data acquisition unit, it can be determined that the relation between the medicine placement unit and the medicine package or the container placed in the medication support apparatus is normal. Due to this configuration, a user can determine whether the relation between the medicine placement unit and the medicine package or the container placed in the medication support apparatus is normal just by receiving the comparison result output by the comparison-result output unit of the checking apparatus. For the above reasons, the workload of checking operation can be reduced compared with cases in which a user visually checks a medicine placement unit against a container or a medicine package stored in the container.

### Second Aspect

In the checking apparatus according to the first aspect, the comparison data acquisition unit reads and obtains the comparison data from a third data retaining medium such as the coded image 551 different from the first data retaining medium and the second data retaining medium.

Due to such a configuration, the workload of obtaining comparison data can be reduced compared with cases in which the comparison data is manually obtained by an operator or worker.

### Third Aspect

In the checking apparatus according to the first or second aspect, the comparison data includes a time of medication.

Due to such a configuration, a relation between a medicine placement unit and a medicine package or a container can be checked for each time of medication such as a time in the morning, a time at lunchtime, a time in the evening, and a time before going to the bed.

### Fourth Aspect

In the checking apparatus according to any one of the first to third aspects, when the inspection unit determines that a relation between the first data read by the first data reader and the second data read by the second data reader is normal based on a check against the comparison data obtained by the comparison data acquisition unit, the comparison-result output unit indicates that the result of the comparison is normal.

Due to such a configuration, it is easy to notify a user of the fact that the relation between the medicine placement unit and the medicine package or the container is normal.

### Fifth Aspect

In the checking apparatus according to any one of the first to fourth aspects, when the inspection unit determines that a relation between the first data read by the first data reader and the second data read by the second data reader is abnormal based on a check against the comparison data obtained by the comparison data acquisition unit, the comparison-result output unit indicates that the result of the comparison is abnormal without outputting personal information about a plurality of patients who take medicines in response to such an abnormality.

Due to such a configuration, it is easy to notify a user of the fact that the relation between the medicine placement unit and the medicine package or the container is found to be abnormal. In so doing, the personal information about the patients who take medicines is not output in response to such an abnormality. Accordingly, the personal information about a patient who take medicines, which corresponds to an abnormal relation between the medicine placement unit and the medicine package or the container, can be prevented from leaking to a user.

### Sixth Aspect

The checking apparatus according to any one of the first to fifth aspects further includes a memory to store the result of the comparison performed by the inspection unit.

Due to such a configuration, the result of comparison stored in the memory can be used for other processes easily.

### Seventh Aspect

A medication support apparatus such as a medicine dispensing system includes a container holder such as the cartridge tray 20 from which a container such as the cartridge 10 storing a medicine package is detachable, a medicine placement unit holder such as the medicine dispensing tray 30 from which a medicine placement unit such as the subdivision box 34 is detachable, a conveyor such as the carriage 50 and the conveyor 90 to pick up the medicine package from the container and convey the medicine package to the medicine placement unit, a first data reader such as the upper QR code reader 66 to read first data such as the medication-related information from a first data retaining medium such as the QR code 6c disposed on a container attached to the container holder or a medicine package stored in the container, a second data reader such as the lower QR code reader 67 to read second data such as the medication-related information from a second data retaining medium such as the QR code 6c disposed on the medicine placement unit attached to the medicine placement unit holder, a controller such as the medicine dispensing controller 150 to control the conveyor based on the first data read by the first data reader and the second data read by the second data reader, and the checking apparatus according to any one of the first to sixth aspects. The inspection unit such as the inspection management system 325 of the checking apparatus checks the comparison data obtained by the comparison data acquisition unit against the first data read by the first data reader and the second data read by the second data reader.

Due to such a configuration, a medication support apparatus can be provided that has a function to check whether the relation between the medicine placement unit and the medicine package or the container placed in the medication support apparatus is normal based on the relation data such as the database file obtained by a relation acquisition unit.

### Eighth Aspect

In the medication support apparatus according to the seventh aspect, when one of the first data and the second data is not yet checked against the comparison data, the comparison-result output unit outputs a result of comparison between the comparison data and another one of the first data and the second data.

Due to such a configuration, even when one of the first data and the second data is not yet checked against the comparison data, a user can check the result of comparison between the comparison data and the other one of the first data and the second data. For example, even when the medicine placement units are attached to the medicine placement unit holder but the containers are not attached to the container holder, a user can check the result of comparison between the comparison data and the other one of the first data and the second data. Accordingly, even in such cases, a user can check the data of the medicine placement unit or the container that corresponds to another piece of information and is included in the comparison data.

### Ninth Aspect

In the medication support apparatus according to the seventh aspect or the eighth aspect, the inspection unit checks the first data and the second data against the comparison data based on the first data read by the first data reader from the first data retaining medium disposed on a plurality of containers attached to the container holder by replacement or the first data retaining medium disposed on the medicine package stored in the plurality of containers.

Due to such a configuration, even when the number of the containers to be checked exceeds the number of the containers that can be attached to the container holder of the medication support apparatus, the checking processes can be performed.

### Tenth Aspect

In the medication support apparatus according to any one of the seventh to ninth aspects, the inspection unit checks the first data and the second data against the comparison data based on the second data read by the second data reader from the second data retaining medium disposed on the plurality of medicine placement units attached to the medicine placement unit holder by replacement.

Due to such a configuration, even when the number of the medicine placement units to be checked exceeds the number of the medicine placement units that can be attached to the medicine placement unit holder of the medication support apparatus, the checking processes can be performed.

### Eleventh Aspect

The medication support apparatus according to any one of the seventh to tenth aspects further includes a plurality of containers including the container, and the plurality of containers are attached to and detached from a plurality of positions of the container holder. The comparison-result output unit outputs data indicating the plurality of positions at which the plurality of containers are disposed such as the position of the cartridge 10 indicated by the first data read by the first data reader.

Due to such a configuration, a user can be notified of to what positions of the container holder of the medication support apparatus the containers included in the comparison result are attached.

### Twelfth Aspect

The medication support apparatus according to any one of the seventh to eleventh aspects further includes a plurality of medicine placement units including the medicine placement unit, and the plurality of medicine placement units are attached to and detached from a plurality of positions of the medicine placement unit holder. The comparison-result output unit outputs data indicating the plurality of positions at which the plurality of medicine placement units are disposed such as the positions of the subdivision boxes 34 indicated by the second data read by the second data reader.

Due to such a configuration, a user can be notified of to what positions of the medicine placement unit holder of the medication support apparatus the medicine placement units included in the comparison result are attached.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

What is claimed is:

1. A checking apparatus comprising
circuitry configured to:
check a relation between a medicine placement unit and one of a container and a medicine package stored in the container;
obtain comparison data;
compare the comparison data with first data read by a first data reader from a first data retaining medium disposed on the one of the container and the medicine package and second data read by a second data reader from a second data retaining medium disposed on the medicine placement unit; and
output a result of comparison performed between the comparison data and each one of the first data and the second data.

2. The checking apparatus according to claim 1,
wherein the circuitry reads and obtains the comparison data from a third data retaining medium different from the first data retaining medium and the second data retaining medium.

3. The checking apparatus according to claim 1,
wherein the comparison data includes a time of medication.

4. The checking apparatus according to claim 1,
wherein when the circuitry determines that a relation between the first data read by the first data reader and the second data read by the second data reader is normal based on a check against the comparison data, the circuitry indicates that the result of the comparison is normal.

5. The checking apparatus according to claim 1,
wherein when the circuitry determines that a relation between the first data read by the first data reader and the second data read by the second data reader is abnormal based on a check against the comparison data, the circuitry indicates that the result of the comparison is abnormal without outputting personal information about a plurality of patients who take medicines to indicate that the relation between the first data and the second data is abnormal.

6. The checking apparatus according to claim 1, further comprising
a memory to store the result of the comparison.

7. A medication support apparatus comprising:
a container holder from which a container storing a medicine package is detachable;
a medicine placement unit holder from which a plurality of medicine placement units are detachable;
a conveyor to pick up the medicine package from the container and convey the medicine package to corresponding one of the plurality of medicine placement units;
a first data reader to read first data from a first data retaining medium disposed on a container attached to the container holder or a medicine package stored in the container;
a second data reader to read second data from a second data retaining medium disposed on each one of the plurality of medicine placement units attached to the medicine placement unit holder;
a controller to control the conveyor based on the first data read by the first data reader and the second data read by the second data reader; and
the checking apparatus according to claim 1,
wherein the circuitry of the checking apparatus checks the first data read by the first data reader and the second data read by the second data reader against the comparison data.

8. The medication support apparatus according to claim 7,
wherein when one of the first data and the second data is not yet checked against the comparison data, the circuitry outputs a result of comparison between the comparison data and another one of the first data and the second data.

9. The medication support apparatus according to claim 7, further comprising
a plurality of containers including the container,
wherein the plurality of containers are attached to the container holder by replacement, and
wherein the circuitry checks the first data and the second data against the comparison data based on the first data read by the first data reader from the first data retaining medium disposed on the plurality of containers or the first data retaining medium disposed on the medicine package stored in the plurality of containers.

10. The medication support apparatus according to claim 7,
wherein the circuitry checks the first data and the second data against the comparison data based on the second data read by the second data reader from the second data retaining medium disposed on the plurality of medicine placement units attached to the medicine placement unit holder by replacement.

11. The medication support apparatus according to claim 7, further comprising
a plurality of containers including the container,
wherein the plurality of containers are attached to and detached from a plurality of positions of the container holder, and
wherein the circuitry outputs data indicating the plurality of positions at which the plurality of containers are disposed indicated by the first data read by the first data reader.

12. The medication support apparatus according to claim 7, further comprising
a plurality of medicine placement units including the medicine placement unit,
wherein the plurality of medicine placement units are attached to and detached from a plurality of positions of the medicine placement unit holder, and
wherein the circuitry outputs data indicating the plurality of positions at which the plurality of medicine placement units are disposed indicated by the second data read by the second data reader.
